(19) United States
(12) Patent Application Publication
(10) Pub. No.: US 2014/0063852 A1
(43) Pub. Date: Mar. 6, 2014

(54) LIGHT GUIDE PLATE, PLANAR LIGHTING DEVICE AND METHOD OF MANUFACTURING LIGHT GUIDE PLATE

(71) Applicant: FUJIFILM CORPORATION, Tokyo (JP)

(72) Inventor: Osamu IWASAKI, Ashigara-kami-gun (JP)

(73) Assignee: FUJIFILM CORPORATION, Tokyo (JP)

(21) Appl. No.: 14/075,666

(22) Filed: Nov. 8, 2013

Related U.S. Application Data
(63) Continuation of application No. PCT/JP2012/061189, filed on Apr. 26, 2012.

(30) Foreign Application Priority Data
May 25, 2011 (JP) 2011-117272

(51) Int. Cl. F21V 8/00

(52) U.S. Cl. CPC G02B 6/0041; G02B 6/0016
USPC 362/613; 362/621; 29/557

(57) ABSTRACT

A light guide plate is provided which is high in light use efficiency, and is capable of emitting light with reduced luminance unevenness and obtaining a convex distribution. The light guide plate includes two or more layers which change in thickness in a direction substantially perpendicular to a light exit surface. A combined particle concentration changes so as to have a first local maximum value on a side closer to each of one or more light incidence surfaces and a second local maximum value which is larger than the first local maximum value. Each of the one or more light incidence surfaces is a roughened surface obtained by forming a cut and polished surface having a given periodic structure in a direction parallel to a longitudinal direction of each of the one or more light incidence surfaces.

### BACKGROUND OF THE INVENTION

The present invention relates to a light guide plate and a planar lighting device that may be used in a liquid crystal display and the like, and a method of manufacturing the light guide plate.

A liquid crystal display uses a planar lighting device (a backlight unit) which illuminates a liquid crystal display panel by irradiation of light from the back side of the liquid crystal display panel. The backlight unit is configured using a light guide plate for diffusing light emitted from an illumination light source to illuminate the liquid crystal display panel and parts such as a prism sheet and a diffusion sheet for making outgoing light from the light guide plate uniform.

Currently, large-sized liquid crystal televisions predominantly use a so-called underneath type backlight unit including a light guide plate disposed immediately above an illumination light source. This type of backlight unit ensures uniform light amount distribution and necessary luminance by disposing a plurality of cold cathode tubes used as light sources behind the liquid crystal display panel and providing the inside of the backlight unit with white reflection surfaces.

However, the underneath type backlight unit requires a thickness of about 30 mm in a direction perpendicular to the liquid crystal display panel in order to make the light amount distribution uniform and further reduction in thickness is difficult to achieve.

On the other hand, an exemplary backlight unit that allows the thickness reduction includes an edge-lit backlight unit using a light guide plate which receives light emitted from an illumination light source, guides the received light in predetermined directions and emits the guided light through a light exit surface that is different from the surface through which the light entered.

It is proposed to use, in such an edge-lit backlight unit, a light guide plate in plate form which is obtained by incorporating scattering particles for scattering light in a transparent resin.

For example, JP 7-36037 A describes a light scattering and guiding light source device comprising a light scattering guide having at least one light incidence surface region and at least one light exit surface region and light source means for light incidence through the light incidence surface region, the light scattering guide having a region that has a tendency to decrease in thickness with increasing distance from the light incidence surface.

In addition, JP 11-345512 A describes a planar light source device comprising a sheet member in which at least one non-scattering light guide region and at least one scattering light guide region containing particles with a different refractive index uniformly dispersed in the same material as the non-scattering light guide region overlap each other, a light source lamp being mounted on each end face, the distribution state of the amount of light emitted from the main surface being controlled by locally adjusting the particle concentration in the sheet thickness of both the regions, the scattering light guide region including convex light guide blocks and the non-scattering light guide region including concave light guide blocks corresponding to the convex light guide blocks.

In such an edge-lit backlight unit, luminance unevenness occurs in illumination light emitted through a light exit surface in the vicinities of light entrance portions due to such a cause as non-uniform light emitted from light sources.

More specifically, a cold cathode tube or a light-emitting diode (hereinafter also referred to as “LED”) is used as the light source of a planar lighting device. Since an electrode is formed on each end of the cold cathode tube, light is not emitted from both the ends of the cold cathode tube and uniform light cannot be emitted. In cases where LEDs are disposed in an array so as to face the end face of a light guide plate and used as light sources, there are spaces between adjacent LEDs and the light-emitting face for light emission is not continuing, and therefore uniform light cannot be emitted as the light sources.

Even in cases where light emitted from a light source is not uniform as above, the light having entered through the end face of a light guide plate is diffused inside the light guide plate or is diffused by a prism sheet or a diffusion sheet before being emitted from a backlight unit as uniform illumination light to some extent. In the vicinity of a light entrance portion of the light guide plate, however, the incident light is not sufficiently diffused before being emitted through a light exit surface and hence luminance unevenness occurs in the illumination light emitted from the backlight unit.

Then, there have been proposed backlight units of a type which diffuses light by applying a roughened surface or a prismatic or lenticular structure to the end face profile of a light guide plate in order to suppress the luminance unevenness in the light entrance portion of the light guide plate.

For example, JP 9-160036 A describes a side-lit planar light source device which deflects illumination light having entered though the end face of a plate member formed so as to decrease in thickness with increasing distance from the end face and emits the deflected illumination light through one face of the plate member, wherein the incident light entering through the end face scatters more at positions closer to both ends of the end face.

JP 11-231320 A describes a side-lit planar light source device in which projections each having a pair of inclines which are substantially perpendicular to a light exit surface are repeatedly formed and these projections are formed so as to have different shapes such that inclines facing on the central side of a light source are larger in the light emitting region of the light source but are smaller in the region distant from the light emitting region. JP 10-253957 A describes a side-lit planar light source device in which projections each having a pair of inclines are repeatedly formed on the incidence surface of a plate member in the longitudinal direction of the incidence surface.

JP 9-160035 A describes a side-lit planar light source device in which an incidence surface of illumination light is roughened so as to have an arithmetic mean roughness Ra of 0.05 to 0.30 μm on the center line of the incidence surface.

JP 2010-182478 A describes a light guide plate having a light incidence surface roughened by forming a cut and polished surface having a given periodic structure in a direction parallel to the longitudinal direction of the light incidence surface.

### SUMMARY OF THE INVENTION

However, the backlight unit of, for example, a tandem type using a light guide plate which decreases in thickness with increasing distance from the light source suffers from inferior light use efficiency to the underneath type in relation to the relative dimensions of the cold cathode tubes and the reflector although the backlight unit can be reduced in thickness.

According to the light guide plate described in JP 11-345512 A, it is possible to make the outgoing light distribution uniform to some extent by using the convex scattering light guide region but adjustment of the shape of the scattering light guide region for optimizing the quantity of outgoing light has not been taken into account.

Further, when a backlight unit is to be made thinner and larger, the particle concentration of scattering particles needs to be reduced in order to guide light deep into the light guide plate but the reduced particle concentration of the scattering particles leads to insufficient diffusion of incident light in the vicinities of light incidence surfaces. Therefore, light emitted from the vicinities of the light incidence surfaces may have visible bright lines (dark lines, unevenness) which are attributable to such causes as the intervals at which light sources are disposed.

On the other hand, a high particle concentration of the scattering particles in the regions in the vicinities of the light incidence surfaces causes light having entered through the light incidence surfaces to be reflected in the regions in the vicinities of the light incidence surfaces. Therefore, the incident light may exit through the light incidence surfaces as return light, or outgoing light from the regions in the vicinities of the light incidence surfaces, which is not used because the regions are covered with the housing, may increase.

One option for emitting uniform light through a light exit surface in a large-sized light guide plate is to increase the number of light sources such as LEDs. However, reduction of power consumption, reduction of the number of parts or other requirement is imposed on liquid crystal displays such as liquid crystal televisions, and an increase in the number of light sources resulting from an increase in size is contrary to these requirements.

As described above, suitable measures including roughening of the light incidence surface and formation of prisms are taken in conventional light guide plates in order to fulfill these requirements.

However, these methods do not sufficiently fulfill the requirements for a larger size, a smaller thickness and a lighter weight.

For example, according to the method which involves forming the roughened light incidence surface in the light guide plate, light is more likely to be emitted in the vicinity of the light entrance portion and therefore a large-sized light guide plate has difficulty in guiding light deep thereinto and uniform light cannot be emitted through the light exit surface. On the other hand, the method which involves forming the prismatic or lenticular structure on the light incidence surface of the light guide plate suffered from the problem that the distance between the light source and the light incidence surface of the light guide plate relatively increases with decreasing thickness of the light guide plate, thus reducing the light incidence efficiency. A method which involves decreasing the size of the prismatic or lenticular structure is possible. However, a structure which is a few micrometers in size is necessary and this method suffers from the problem that it is difficult to form the structure not only in manufacturing a mold but also in actually molding a light guide plate, thus leading to an increase in cost.

In cases where LEDs are disposed in an array so as to face the end face of a light guide plate and used as light sources, the luminance unevenness of illumination light emitted from the backlight unit can be reduced by decreasing the distance between adjacent LEDs. However, this configuration suffers from the problem that an increased number of mounted LEDs increases power consumption, leading to an increase in cost.

An object of the present invention is to solve the problems associated with the foregoing prior art and to provide a large-sized thin light guide plate which is high in light use efficiency, and is capable of emitting light with reduced unevenness in luminance and obtaining a so-called convex or bell-shaped brightness distribution, that is, such a distribution that an area around the center of the screen is brighter than the periphery as required of a flat large-screen liquid crystal television.

Another object of the invention is to provide a light guide plate capable of reducing return light, which is outgoing light through the light incidence surfaces after it once enters the light guide plate, and also reducing outgoing light from the regions in the vicinities of the light incidence surfaces which is not used because the regions are covered with the housing, whereupon the use efficiency of outgoing light through the effective region of the light exit surface can be improved.

Still another object of the invention is to provide a light guide plate capable of sufficiently diffusing incident light in the vicinities of the light incidence surfaces to prevent outgoing light from the vicinities of the light incidence surfaces from having visible bright lines (dark lines, unevenness) which are attributable to such causes as intervals at which the light sources are disposed.

In order to achieve the above-described objects, the present invention provides a light guide plate comprising: a rectangular light exit surface; one or more light incidence surfaces which are provided on one or more end sides of the light exit surface and through which light traveling in a direction substantially parallel to the light exit surface enters; a rear surface on an opposite side to the light exit surface; and scattering particles dispersed in the light guide plate; wherein the light guide plate includes two or more layers superposed on each other in a direction substantially perpendicular to the light exit surface and containing the scattering particles at different particle concentrations, wherein thicknesses of the two or more layers in the direction substantially perpendicular to the light exit surface change so that a combined particle concentration has, in a direction perpendicular to each of the one or more light incidence surfaces, a first local maximum value located on a side closer to each of the one or more light incidence surfaces and a second local maximum value located at a position farther from the one or more light incidence surfaces than one or more positions of the first local maximum value and being larger than the first local maximum value, and wherein each of the one or more light incidence surfaces is a roughened surface obtained by forming a cut and polished surface having a given periodic structure in a direction parallel to a longitudinal direction of each of the one or more light incidence surfaces.

Preferably, the two or more layers comprise two layers including a first layer disposed on a side closer to the light exit surface and a second layer disposed on a side closer to the rear surface and containing the scattering particles at a higher particle concentration than the first layer, and a thickness of the second layer continuously changes in the direction perpendicular to each of the one or more light incidence surfaces so as to increase with increasing distance from each of the one or more light incidence surfaces, then decrease and subsequently increase again.

In order to achieve the above-described objects, the present invention also provides a light guide plate comprising: a rectangular light exit surface; one or more light incidence surfaces which are provided on one or more end sides of the light exit surface and through which light traveling in a direction substantially parallel to the light exit surface enters; a rear surface on an opposite side to the light exit surface; and scattering particles dispersed in the light guide plate; wherein the light guide plate includes two or more layers superposed on each other in a direction substantially perpendicular to the light exit surface and containing the scattering particles at different particle concentrations, wherein thicknesses of the two or more layers in the direction substantially perpendicular to the light exit surface change so that a combined particle concentration has, in a direction perpendicular to each of the one or more light incidence surfaces, a local minimum value located on a side closer to each of the one or more light incidence surfaces and a second local maximum value located at a position farther from the one or more light incidence surfaces than one or more positions of the local minimum value, and wherein each of the one or more light incidence surfaces is a roughened surface obtained by forming a cut and polished surface having a given periodic structure in a direction parallel to a longitudinal direction of each of the one or more light incidence surfaces.

Preferably, the two or more layers comprise two layers including a first layer disposed on a side closer to the light exit surface and a second layer disposed on a side closer to the rear surface and containing the scattering particles at a higher particle concentration than the first layer, and a thickness of the second layer continuously changes in the direction perpendicular to each of the one or more light incidence surfaces so as to decrease with increasing distance from each of the one or more light incidence surfaces and subsequently increase.

Preferably, the one or more light incidence surfaces comprise two light incidence surfaces provided on two opposite end sides of the light exit surface and the combined particle concentration has the first local maximum value on both sides closer to the two light incidence surfaces.

The second layer preferably has a maximum thickness at a central portion of the light exit surface.

Preferably, the one or more light incidence surfaces comprise a light incidence surface provided on one end side of the light exit surface and the combined particle concentration has the first local maximum value at one position.

Preferably, each of the one or more light incidence surfaces is the roughened surface obtained by forming a linear and uneven structure extending in a lateral direction perpendicular to the longitudinal direction of each of the one or more light incidence surfaces.

The cut and polished surface formed so as to serve as each of the one or more light incidence surfaces preferably has a root-mean-square slope of 0.25 or more but 4.5 or less.

The scattering particles are preferably polydisperse particles including a mixture of particles with different particle sizes.

The rear surface is preferably a flat surface parallel to the light exit surface.

In order to achieve the above-described objects, the present invention also provides a method of manufacturing the light guide plate described above, comprising the steps of: forming an unprocessed light guide plate comprising the two or more layers containing the scattering particles at the different particle concentrations, the light exit surface, and one or more unroughened light incidence surfaces; and subjecting the one or more unroughened light incidence surfaces to machining to form one or more cut and polished surfaces.

The machining is preferably performed by hairline finish.

Preferably, a movement speed and a rotation speed of a blade in a milling machine, an NC router or a planer is adjusted to control a period of contact between the one or more unroughened light incidence surfaces of the unprocessed light guide plate and the blade, thereby subjecting the one or more unroughened light incidence surfaces to the machining for forming the one or more cut and polished surfaces using the blade.

In order to achieve the above-described objects, the present invention also provides a planar lighting device comprising: the light guide plate described above; and one or more light source units each disposed along a longitudinal direction of its corresponding light incidence surface in the one or more light incidence surfaces so as to face the corresponding light incidence surface of the light guide plate.

Preferably, each of the one or more light source units comprises a plurality of point light sources disposed at equal intervals in the longitudinal direction of each of the one or more light incidence surfaces so as to face each of the one or more light incidence surfaces, and a support member for supporting the plurality of point light sources.

Preferably, a length of each of the plurality of point light sources in a direction in which the plurality of point light sources are arranged is from 2 mm to 4 mm, and one or more cut and polished surfaces formed so as to serve as the one or more light incidence surfaces have a periodic structure with a pitch of 5 μm to 0.4 mm.

According to the invention, the light guide plate has a thin shape, is high in light use efficiency, and is capable of emitting light with reduced unevenness in luminance and obtaining a so-called convex or bell-shaped brightness distribution, that is, such a distribution that an area around the center of the screen is brighter than the periphery as required of a flat large-screen liquid crystal television.

According to the invention, the scattering particle concentration in the vicinities of the light incidence surfaces can be reduced to decrease return light, which is outgoing light through the light incidence surfaces, and outgoing light from the regions in the vicinities of the light incidence surfaces which is not used because the regions are covered with the housing, whereupon the use efficiency of outgoing light through the effective region of the light exit surface can be improved.

According to the invention, the combined particle concentration has the first local maximum value in the vicinities of the light incidence surfaces and the light incidence surfaces are roughened where cut and polished surfaces each having a given periodic structure are formed in a direction parallel to the longitudinal direction of each of the light incidence surfaces, and therefore incident light through the light incidence surfaces can be sufficiently diffused to prevent bright lines (dark lines, unevenness), which are attributable to such causes as intervals at which the light sources are disposed, from occurring in the vicinities of the light incidence surfaces.

### BRIEF DESCRIPTION OF THE DRAWINGS

FIG. 1 is a schematic perspective view showing an embodiment of a liquid crystal display provided with a planar lighting device using a light guide plate according to the invention.

FIG. 2 is a cross-sectional view of the liquid crystal display shown in FIG. 1 taken along line II-II.

FIG. 3A is a view of the planar lighting device shown in FIG. 2 taken along line III-III and FIG. 3B is a cross-sectional view of FIG. 3A taken along line B-B.

FIG. 4A is a perspective view showing the schematic configuration of a light source unit of the planar lighting device shown in FIGS. 1 and 2, and FIG. 4B is an enlarged schematic perspective view showing one of LEDs of the light source unit shown in FIG. 4A.

FIG. 5 is a schematic perspective view showing the shape of the light guide plate shown in FIG. 3A.

FIG. 6 is a partially enlarged cross-sectional view of the light guide plate shown in FIG. 3A.

FIGS. 7A and 7B are enlarged schematic views showing a part of the planar lighting device shown in FIGS. 3A and 3B.

FIGS. 8A to 8E are schematic cross-sectional views showing other examples of the light guide plate of the invention.

FIG. 9 is a schematic cross-sectional view showing another example of the light guide plate of the invention.

FIGS. 10A to 10F are schematic cross-sectional views showing planar lighting devices using other examples of the light guide plate of the invention.

FIG. 11 is a schematic cross-sectional view showing a planar lighting device using another example of the light guide plate of the invention.

FIG. 12A is a diagram showing the measurement results of the surface roughness of a cut and polished surface formed in the light guide plate of the planar lighting device shown in FIG. 6 as measured in a direction parallel to the longitudinal direction of each of the light incidence surfaces; and FIG. 12B is a diagram showing FIG. 12A after conversion to Fourier spectrum.

FIG. 13A is a diagram showing the measurement results of the surface roughness of the cut and polished surface of the light guide plate used in the measurement; and FIG. 13B is a diagram showing FIG. 13A after conversion to Fourier spectrum.

FIG. 14A is a diagram showing the measurement results of the surface roughness of the cut and polished surface of the light guide plate used in the measurement; and FIG. 14B is a diagram showing FIG. 14A after conversion to Fourier spectrum.

FIG. 15A is a diagram showing the measurement results of the surface roughness of the cut and polished surface of the light guide plate used in the measurement; and FIG. 15B is a diagram showing FIG. 15A after conversion to Fourier spectrum.

FIG. 16A is a diagram showing the measurement results of the surface roughness of the cut and polished surface of the light guide plate used in the measurement; and FIG. 16B is a diagram showing FIG. 16A after conversion to Fourier spectrum.

FIG. 17A is a diagram showing the measurement results of the surface roughness of the cut and polished surface of the light guide plate used in the measurement; and FIG. 17B is a diagram showing FIG. 17A after conversion to Fourier spectrum.

FIG. 18A is a diagram showing the measurement results of the surface roughness of the cut and polished surface of the light guide plate used in the measurement; and FIG. 18B is a diagram showing FIG. 18A after conversion to Fourier spectrum.

FIG. 19A is a diagram showing the measurement results of the surface roughness of the cut and polished surface of the light guide plate used in the measurement; and FIG. 19B is a diagram showing FIG. 19A after conversion to Fourier spectrum.

FIG. 20A is a diagram showing the measurement results of the surface roughness of the cut and polished surface of the light guide plate used in the measurement; and FIG. 20B is a diagram showing FIG. 20A after conversion to Fourier spectrum.

FIG. 21A is a diagram showing the measurement results of the surface roughness of the cut and polished surface of the light guide plate used in the measurement; and FIG. 21B is a diagram showing FIG. 21A after conversion to Fourier spectrum.

FIG. 22A is a diagram showing the measurement results of the surface roughness of the cut and polished surface of the light guide plate used in the measurement; and FIG. 22B is a diagram showing FIG. 22A after conversion to Fourier spectrum.

FIG. 23A is a diagram showing the measurement results of the surface roughness of the cut and polished surface of the light guide plate used in the measurement; and FIG. 23B is a diagram showing FIG. 23A after conversion to Fourier spectrum.

FIGS. 24A to 24D are graphs showing the measured illuminance.

FIG. 25 is a graph showing the relation between the average angle of inclination and the visibility.

FIG. 26 is a graph showing the light use efficiency.

FIG. 27 is a graph showing the relation between the average angle of inclination and the root-mean-square slope.

FIG. 28A is a spectral distribution diagram of an example of a lenticular structure; and FIG. 28B is a spectral distribution diagram of another example of the lenticular structure.

FIG. 29A is a spectral distribution diagram of an example of a prismatic structure; and FIG. 29B is a spectral distribution diagram of another example of the prismatic structure.

FIG. 30A is a spectral distribution diagram of an example of a rectangular groove structure; and FIG. 30B is a spectral distribution diagram of another example of the rectangular groove structure.

### DETAILED DESCRIPTION OF THE INVENTION

A planar lighting device using a light guide plate according to the invention will be described below in detail with reference to preferred embodiments shown in the accompanying drawings.

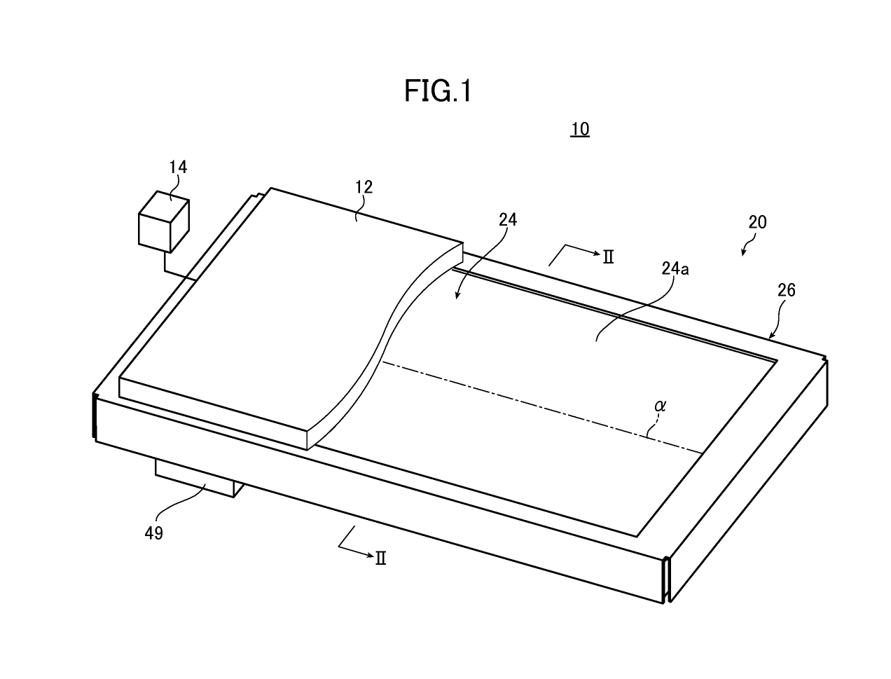

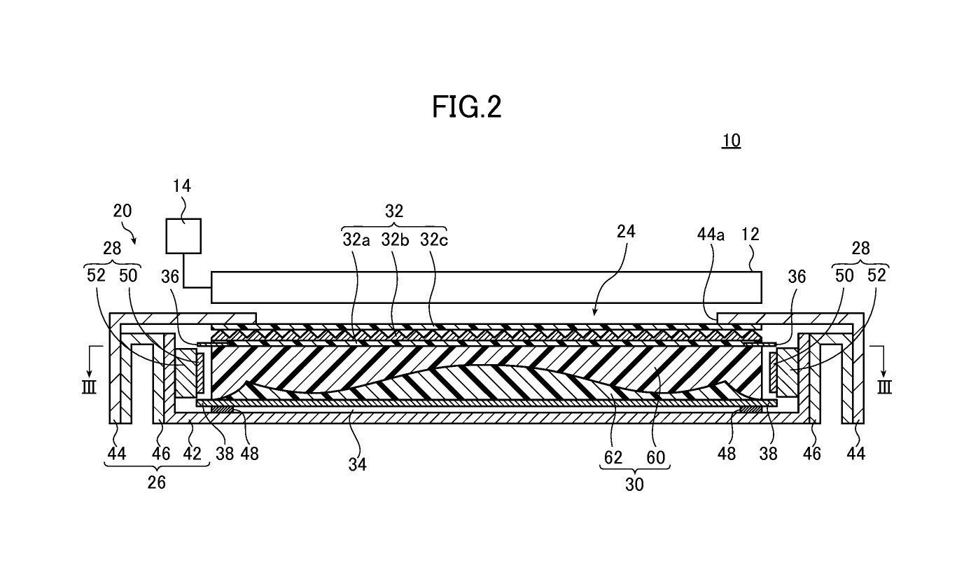

FIG. 1 is a perspective view schematically showing a liquid crystal display provided with the planar lighting device using the light guide plate according to the invention and FIG. 2 is a cross-sectional view of the liquid crystal display shown in FIG. 1 taken along line II-II.

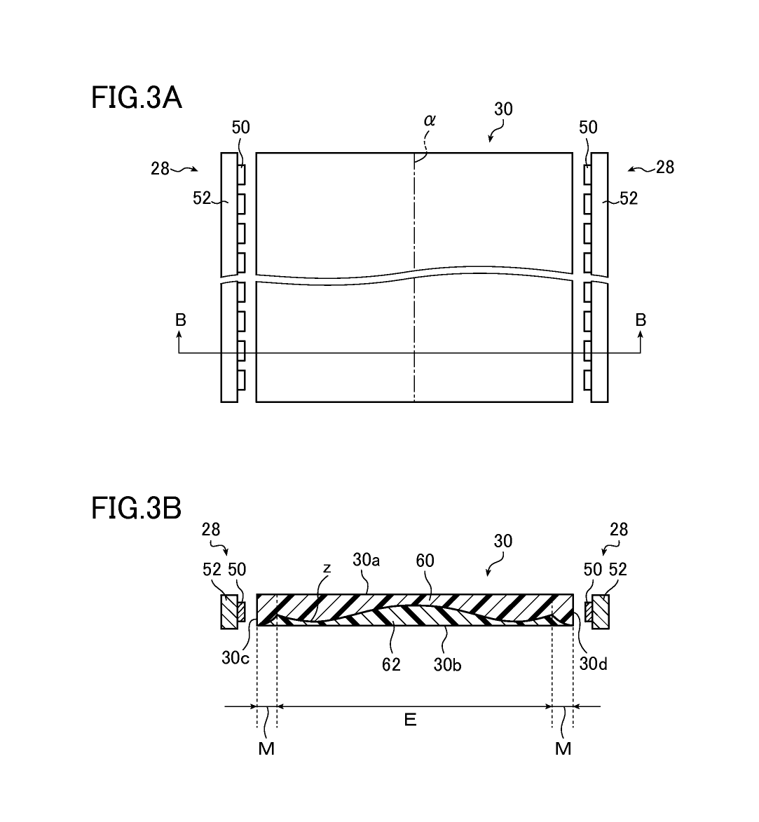

FIG. 3A is a view of the planar lighting device (also referred to below as “backlight unit”) shown in FIG. 2 taken along line III-III and FIG. 3B is a cross-sectional view of FIG. 3A taken along line B-B.

A liquid crystal display 10 includes a backlight unit 20, a liquid crystal display panel 12 disposed on the side closer to a light exit surface 24a of the backlight unit 20, and a drive unit 14 for driving the liquid crystal display panel 12. In FIG. 1, part of the liquid crystal display panel 12 is not shown to illustrate the configuration of the backlight unit.

In the liquid crystal display panel 12, an electric field is partially applied to liquid crystal molecules previously arranged in a specified direction to thereby change the orientation of the molecules. The resultant changes in refractive index having occurred in the liquid crystal cells are used to display characters, figures, images and the like on the surface of the liquid crystal display panel 12.

The drive unit 14 applies a voltage to transparent electrodes in the liquid crystal display panel 12 to change the orientation of the liquid crystal molecules, thereby controlling the transmittance of light passing through the liquid crystal display panel 12.

The backlight unit 20 is a lighting device for illuminating the whole surface of the liquid crystal display panel 12 from behind the liquid crystal display panel 12 and includes the light exit surface 24a of which the shape is substantially the same as an image display surface of the liquid crystal display panel 12.

As shown in FIGS. 1, 2, 3A and 3B, the backlight unit 20 according to this embodiment includes a lighting device main body 24 having two light source units 28, a light guide plate 30 and an optical member unit 32, and a housing 26 having a lower housing 42, an upper housing 44, bent members 46 and support members 48. As shown in FIG. 1, a power unit casing 49 containing a plurality of power supplies for supplying the light source units 28 with electric power is provided on the back side of the lower housing 42 of the housing 26.

Now, components constituting the backlight unit 20 will be described.

The lighting device main body 24 includes the light source units 28 for emitting light, the light guide plate 30 for emitting the light from the light source units 28 as planar light, and the optical member unit 32 for scattering and diffusing the light emitted from the light guide plate 30 to further reduce the unevenness of the light.

First, the light source units 28 will be described.

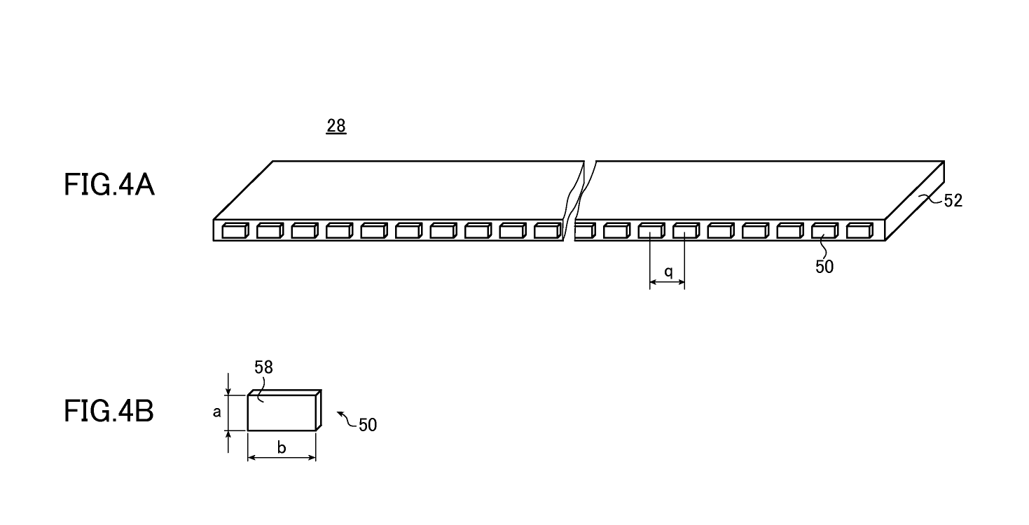

FIG. 4A is a schematic perspective view schematically showing the configuration of the light source unit 28 of the backlight unit 20 shown in FIGS. 1 and 2; and FIG. 4B is an enlarged schematic perspective view showing only one LED chip of the light source unit 28 shown in FIG. 4A.

As shown in FIG. 4A, the light source unit 28 includes a plurality of light-emitting diode chips (referred to below as “LED chips”) 50 and a light source support 52.

The LED chip 50 is a chip of a light-emitting diode emitting blue light, which has a phosphor applied on the surface thereof. It has a light-emitting face 58 with a predetermined area through which white light is emitted.

Specifically, when blue light emitted through the surface of the light-emitting diode of the LED chip 50 passes through the phosphor, the phosphor emits fluorescence. Thus, the blue light emitted from the light-emitting diode is combined with the light emitted as a result of the fluorescence of the phosphor to produce white light, which is emitted from the LED chip 50.

An example of the LED chip 50 includes a chip obtained by applying a YAG (yttrium aluminum garnet) phosphor to the surface of a GaN light-emitting diode, an InGaN light-emitting diode, and the like.

The light source support 52 is a plate member disposed so that one surface thereof faces a light incidence surface 30c or 30d of the light guide plate 30.

The light source support 52 carries the LED chips 50 on its lateral surface facing the light incidence surface (30c or 30d) of the light guide plate 30 so that the LED chips 50 are spaced apart from each other at predetermined intervals. More specifically, the LED chips 50 constituting the light source unit 28 are arrayed along the longitudinal direction of the first light incidence surface 30c or the second light incidence surface 30d of the light guide plate 30 to be described later and are secured onto the light source support 52.

The light source support 52 is formed of a metal having high heat conductivity such as copper or aluminum and also serves as a heat sink which absorbs heat generated from the LED chips 50 and releases the absorbed heat to the outside. The light source support 52 may be equipped with fins capable of increasing the surface area and the heat dissipation effect or heat pipes for transferring heat to a heat dissipating member.

As shown in FIG. 4B, the LED chips 50 according to this embodiment each have such a rectangular prism shape that the sides in a direction orthogonal to the direction in which the LED chips 50 are arrayed are shorter than the sides lying in the direction in which the LED chips 50 are arrayed, that is, the sides lying in the direction of the thickness of the light guide plate 30 to be described later (the direction perpendicular to a light exit surface 30a) are shorter sides. In other words, the LED chips 50 each have a shape satisfying b>a where “a” denotes the length of the side in a direction perpendicular to the light exit surface 30a of the light guide plate 30 and “b” denotes the length of the side in the array direction. Now, given “q” as the distance by which the arrayed LED chips 50 are spaced apart from each other, then q>b holds. Thus, the length “a” of the side of the LED chips 50 in the direction perpendicular to the light exit surface 30a of the light guide plate 30, the length “b” of the side in the array direction, and the distance “q” by which the LED chips 50 are spaced apart from each other preferably have a relationship satisfying q>b>a.

The LED chips 50 each having a rectangular prism shape allow a thinner design of the light source unit to be achieved while keeping the output of a large amount of light. A thinner light source unit 28, in turn, permits the reduction of the thickness of the backlight unit. Further, the number of LED chips that need to be arranged can be reduced.

While the LED chips 50 each preferably have a rectangular prism shape with the shorter sides lying in the direction of the thickness of the light guide plate 30 for a thinner design of the light source unit 28, the invention is not limited thereto and LED chips having various shapes including a square shape, a circular shape, a polygonal shape and an elliptical shape may be used.

Next, the light guide plate 30 will be described.

FIG. 5 is a schematic perspective view showing the shape of the light guide plate.

As shown in FIGS. 2, 3A, 3B and 5, the light guide plate 30 includes the rectangular light exit surface 30a; the two light incidence surfaces (the first light incidence surface 30c and the second light incidence surface 30d) formed at both ends on the longer sides of the light exit surface 30a and substantially perpendicular to the light exit surface 30a; and a flat rear surface 30b located on the opposite side from the light exit surface 30a, that is, on the back side of the light guide plate 30.

In the following description, the first light incidence surface 30c and the second light incidence surface 30d are also simply referred to as “light incidence surfaces” if there is no need to distinguish these light incidence surfaces from each other.

The two light source units 28 mentioned above are disposed so as to face the first light incidence surface 30c and the second light incidence surface 30d of the light guide plate 30, respectively. In this embodiment, the light-emitting face 58 of each LED chip 50 in the light source units 28 has substantially the same length as the first light incidence surface 30c and the second light incidence surface 30d in the direction substantially perpendicular to the light exit surface 30a.

Thus, the backlight unit 20 has the two light source units 28 disposed so as to sandwich the light guide plate 30 therebetween. In other words, the light guide plate 30 is disposed between the two light source units 28 so that the former faces the latter at a predetermined distance from each other.

The light guide plate 30 is formed by kneading and dispersing scattering particles for light scattering in a transparent resin. Exemplary materials of the transparent resin that may be used for the light guide plate 30 include optically transparent resins such as PET (polyethylene terephthalate), PP (polypropylene), PC (polycarbonate), PMMA (polymethyl methacrylate), benzyl methacrylate, MS resin, and COP (cycloolefin polymer). Fine particles including silicone particles (e.g., TOSPEARL (registered trademark)), silica particles, zirconia particles and dielectric polymer particles may be used for the scattering particles to be kneaded and dispersed in the light guide plate 30.

The light guide plate 30 is of a two-layer structure including a first layer 60 on the side closer to the light exit surface 30a and a second layer 62 on the side closer to the rear surface 30b. When the boundary between the first layer 60 and the second layer 62 is referred to as “interface z”, the first layer 60 has a sectional region surrounded by the light exit surface 30a, the first light incidence surface 30c, the second light incidence surface 30d and the interface z, and the second layer 62 is a layer adjacent to the first layer on the side closer to the rear surface 30b and has a sectional region surrounded by the interface z and the rear surface 30b.

Now, the particle concentration of the scattering particles in the first layer 60 and that of the scattering particles in the second layer 62 are denoted by Npo and Npr, respectively. Then, Npo and Npr have a relationship expressed by Npo<Npr. Thus, in the light guide plate 30, the second layer 62 on the side closer to the rear surface 30b contains the scattering particles at a higher particle concentration than the first layer 60 on the side closer to the light exit surface 30a.

When seen in the cross section perpendicular to the longitudinal direction of the light incidence surface, the interface z between the first layer 60 and the second layer 62 continuously changes so that the second layer 62 decreases in thickness from the position of the bisector a of the light exit surface 30a (i.e., the central portion of the light exit surface 30a) toward the first light incidence surface 30c and the second light incidence surface 30d, and then continuously changes so that the second layer 62 increases in thickness in the vicinities of the first light incidence surface 30c and the second light incidence surface 30d and decreases in thickness again.

More specifically, the interface z includes a curved surface convex toward the light exit surface 30a in the central portion of the light guide plate 30, concave curved surfaces smoothly connected to the convex curved surface, and concave curved surfaces connected to the concave curved surfaces and communicating with ends of the light incidence surfaces 30c and 30d on the side closer to the rear surface 30b. The thickness of the second layer 62 at the light incidence surfaces 30c and 30d is zero.

By thus continuously changing the thickness of the second layer 62 containing scattering particles at a higher particle concentration than that in the first layer 60 such that the second layer has a first local maximum value as a result of an increased thickness in the vicinities of the light incidence surfaces and a second local maximum value at the central portion of the light guide plate having the largest thickness, the combined particle concentration of the scattering particles is changed so as to have the first local maximum value at the position in the vicinity of each of the first and second light incidence surfaces (30c and 30d) and the second local maximum value at the central portion of the light guide plate, the second local maximum value being larger than the first local maximum value.

More specifically, the profile of the combined particle concentration has a curve which has the second local maximum value that is the largest at the center of the light guide plate 30 and which changes on both sides so as to have the local minimum value at positions away by about two-thirds of the distance from the center to the light incidence surfaces (30c and 30d) and to further have the first local maximum value on the sides closer to the light incidence surfaces than the positions of the local minimum value in the illustrated example.

The combined particle concentration as used in the invention denotes a concentration of scattering particles expressed using the amount of scattering particles added or combined in a direction substantially perpendicular to the light exit surface at a position spaced apart from one light incidence surface toward the opposite light incidence surface on the assumption that the light guide plate is a flat plate having the thickness at the light incidence surfaces throughout the light guide plate. In other words, the combined particle concentration denotes a quantity per unit volume of scattering particles or a weight percentage with respect to the base material of scattering particles added in a direction substantially perpendicular to the light exit surface at a position spaced apart from the light incidence surface on the assumption that the light guide plate is a flat light guide plate which has the thickness at the light incidence surfaces throughout the light guide plate and in which the concentration is the same.

The first local maximum value in the thickness of the second layer 62 (combined particle concentration) is located at the edges of an opening 44a of the upper housing 44 (FIG. 2). The regions from the light incidence surfaces 30c and 30d to their corresponding positions of the first local maximum value are located outside the opening 44a of the upper housing 44, that is, in the frame portions forming the opening 44a, and therefore does not contribute to the emission of light as the backlight unit 20. In other words, the regions from the light incidence surfaces 30c and 30d to their corresponding positions of the first local maximum value are so-called mixing zones M for diffusing light having entered through the light incidence surfaces. The region on the center side of the light guide plate from the mixing zones M, that is, the region corresponding to the opening 44a of the upper housing 44 is an effective screen area E and is a region contributing to the emission of light as the backlight unit 20.

By thus adjusting the combined particle concentration of the light guide plate 30 (thickness of the second layer) so that the concentration has the second local maximum value which is the largest at the central portion of the light guide plate, incident light through the light incidence surfaces 30c and 30d can travel to positions farther from the light incidence surfaces 30c and 30d even if the light guide plate is large and thin, whereupon outgoing light may have a luminance distribution which is high in the middle.

By adjusting the combined particle concentration so as to have the first local maximum value in the vicinities of the light incidence surfaces 30c and 30d, incident light through the light incidence surfaces 30c and 30d can be sufficiently diffused in the vicinities of the light incidence surfaces to prevent outgoing light from the vicinities of the light incidence surfaces from having visible bright lines (dark lines, unevenness) which are attributable to such causes as intervals at which the light sources are disposed.

By adjusting the combined particle concentration so that the regions on the sides closer to the light incidence surfaces 30c and 30d than the positions where the combined particle concentration takes the first local maximum value have a lower combined particle concentration than the first local maximum value, return light, which is light outgoing through the light incidence surface after it once enters the light guide plate, and outgoing light from the regions in the vicinities of the light incidence surfaces (mixing zones M) which is not used because the regions are covered with the housing can be reduced to improve the use efficiency of outgoing light through the effective region of the light exit surface (effective screen area E).

By setting the positions where the combined particle concentration takes the first local maximum value on the sides closer to the light incidence surfaces 30c and 30d than the opening 44a of the upper housing 44, outgoing light from the regions in the vicinities of the light incidence surfaces (mixing zones M) which is not used because the regions are covered with the housing can be reduced to improve the use efficiency of outgoing light through the effective region of the light exit surface (effective screen area E).

The adjustment of the shape of the interface z enables the luminance distribution (concentration distribution of the scattering particles) as well to be set as desired to improve the efficiency to the maximum extent possible.

In addition, since the particle concentration of the layer on the side closer to the light exit surface is reduced, the total amount of the scattering particles used can be reduced, thus leading to cost reduction.

In the illustrated embodiment, the combined particle concentration is adjusted so as to have the first local maximum value at the edges of the opening 44a of the upper housing 44. However, this is not the sole case of the invention and the combined particle concentration may have the first local maximum value at positions inside the opening 44a or in the frame portions of the surface having the opening 44a of the upper housing 44 (outside the opening 44a) as long as the first local maximum value of the combined particle concentration is located near the edges of the opening 44a of the upper housing 44. In other words, the combined particle concentration may have the first local maximum value at positions in the effective screen area E or at positions in the mixing zones M.

Although the light guide plate 30 is divided into the first layer 60 and the second layer 62 by the interface z, the first layer 60 and the second layer 62 are obtained by dispersing the same scattering particles in the same transparent resin and have an integrated structure, the only difference being the particle concentration. That is, the light guide plate 30 has different particle concentrations in the respective regions on both sides of the interface z which serves as a reference but the interface z is a virtual face and the first layer 60 is integrated with the second layer 62.

The light guide plate 30 as described above may be manufactured using an extrusion molding method or an injection molding method.

When the combined particle concentration in the vicinities of the light incidence surfaces is reduced as in a large-sized light guide plate or the light guide plate 30, the luminance unevenness (also referred to as “firefly phenomenon”) due to the spaces between the adjacent LED chips 50 is more likely to occur in the vicinities of the light incidence surfaces. Therefore, according to the invention, the light incidence surfaces are roughened to diffuse incident light thereby suppressing the occurrence of unevenness.

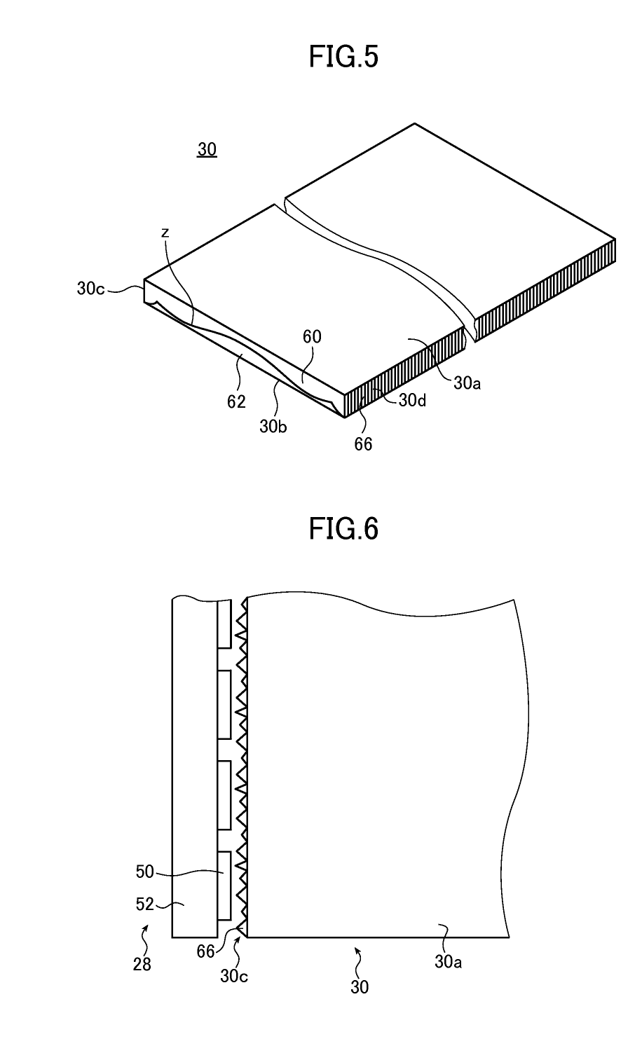

More specifically, as shown in FIGS. 5 and 6, each of the light incidence surfaces (the first light incidence surface 30c and the second light incidence surface 30d) of the light guide plate 30 is formed so as to have a cut and polished surface 66 having a given periodic structure in a direction parallel to the longitudinal direction of each of the light incidence surfaces. In other words, the cut and polished surface 66 has a lot of minute asperities in the shape of vertical streaks extending in the direction perpendicular to the light exit surface 30a and is a roughened surface having the given periodic structure in the direction parallel to the direction in which the LED chips 50 of the light source unit 28 are arranged.

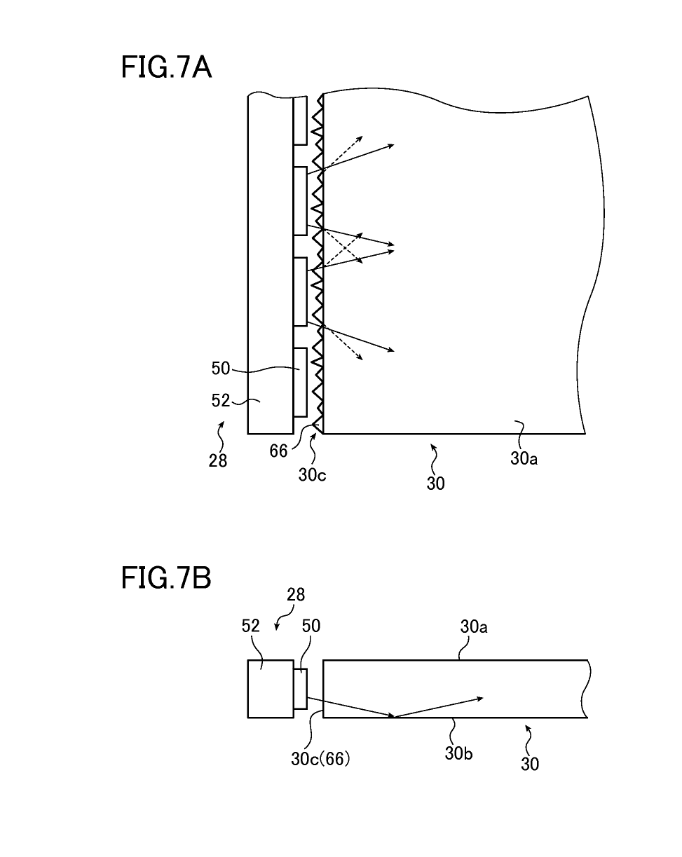

FIGS. 7A and 7B are enlarged schematic views conceptually showing a part of the backlight unit 20.

The cut and polished surfaces 66 formed as the light incidence surfaces 30c and 30d of the light guide plate 30 each have the given periodic structure in the longitudinal direction of each of the light incidence surfaces 30c and 30d, and hence light is diffused in the longitudinal direction of each of the light incidence surfaces 30c and 30d as shown in FIG. 7A (light having entered as shown by solid lines is diffused as shown by broken lines). Therefore, the luminance unevenness due to spaces between the adjacent LED chips 50 can be reduced. On the other hand, as shown in FIG. 7B, light is not diffused in the direction perpendicular to the light exit surface 30a (light is guided as shown by a solid line).

Accordingly, even in a large and thin light guide plate, light having entered the light guide plate 30 can be guided deep into the light guide plate 30 while suppressing the luminance unevenness in the vicinities of the light incidence surfaces 30c and 30d. Since light does not diffuse in the direction perpendicular to the light exit surface 30a of the light guide plate, light having entered the light guide plate 30 can be guided deep thereinto and uniform light can be emitted from the light guide plate 30 even if it is of a large size.

In the specification, incident light which diffuses in the longitudinal direction of each of the light incidence surfaces 30c and 30d but not in the direction parallel to each of the lateral surfaces is referred to as “directional” light.

As described above, the cut and polished directional surfaces 66 are formed as the light incidence surfaces 30c and 30d of the light guide plate 30 and incident light is diffused in the longitudinal direction of each of the light incidence surfaces 30c and 30d, and therefore the luminance unevenness in the vicinities of the light incidence surfaces 30c and 30d can be suppressed. Since light does not diffuse in the direction perpendicular to the light exit surface 30a, light having entered the light guide plate 30 can be guided deep thereinto and uniform light can be emitted from the light guide plate 30 even if it is of a large size.

Particularly even in cases where the light source unit 28 including the arrayed LED chips 50 is used and non-uniform light enters due to spaces between the adjacent LED chips 50, the cut and polished surfaces 66 each having the periodic structure can be formed as the light incidence surfaces 30c and 30d of the light guide plate 30 to make outgoing light through the light exit surface 30a of the light guide plate 30 uniform and hence to reduce the number of the LED chips 50 to be mounted, which makes it possible to reduce power consumption and costs.

In cases where the light incidence surface has a lenticular or prismatic structure formed therein as in the prior art to diffuse incidence light, the distance between the light source and the light incidence surface of the light guide plate relatively increases with decreasing thickness of the light guide plate, thus reducing the light incidence efficiency. Therefore, the lenticular or prismatic structure is to be reduced in size but is difficult to manufacture and also increases the cost.

In contrast, since the asperities of the cut and polished surface formed in the light guide plate 30 of the invention are minute as compared to the lenticular or prismatic structure, the distance between the light incidence surface 30c of the light guide plate 30 and the light source unit 28 can be reduced to maintain and improve the light use efficiency.

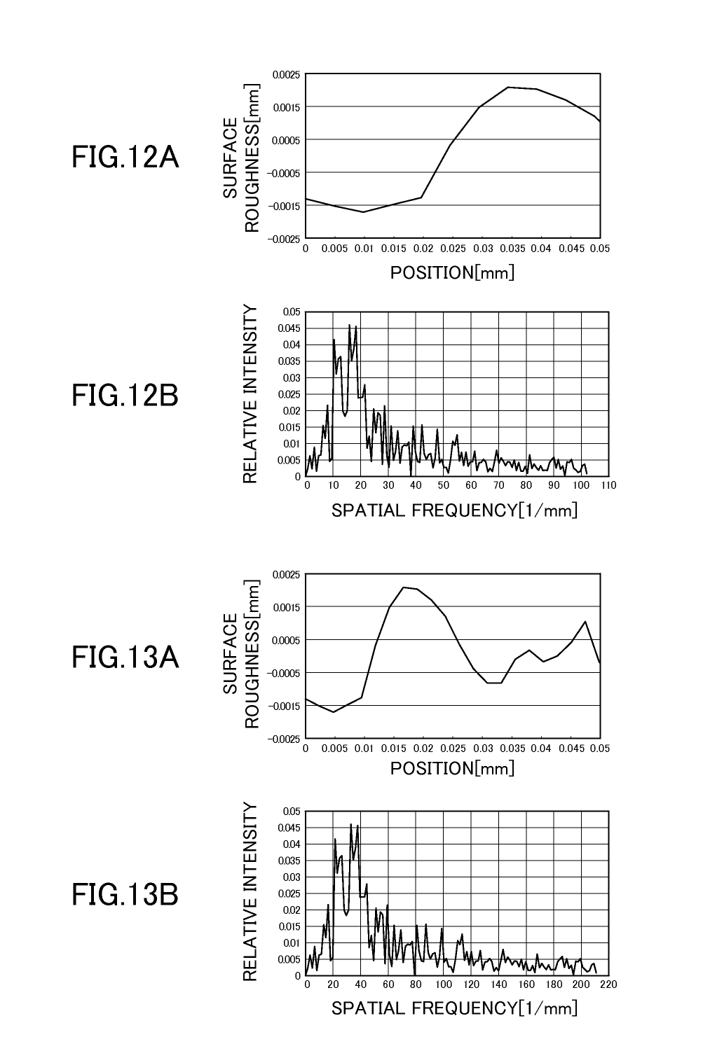

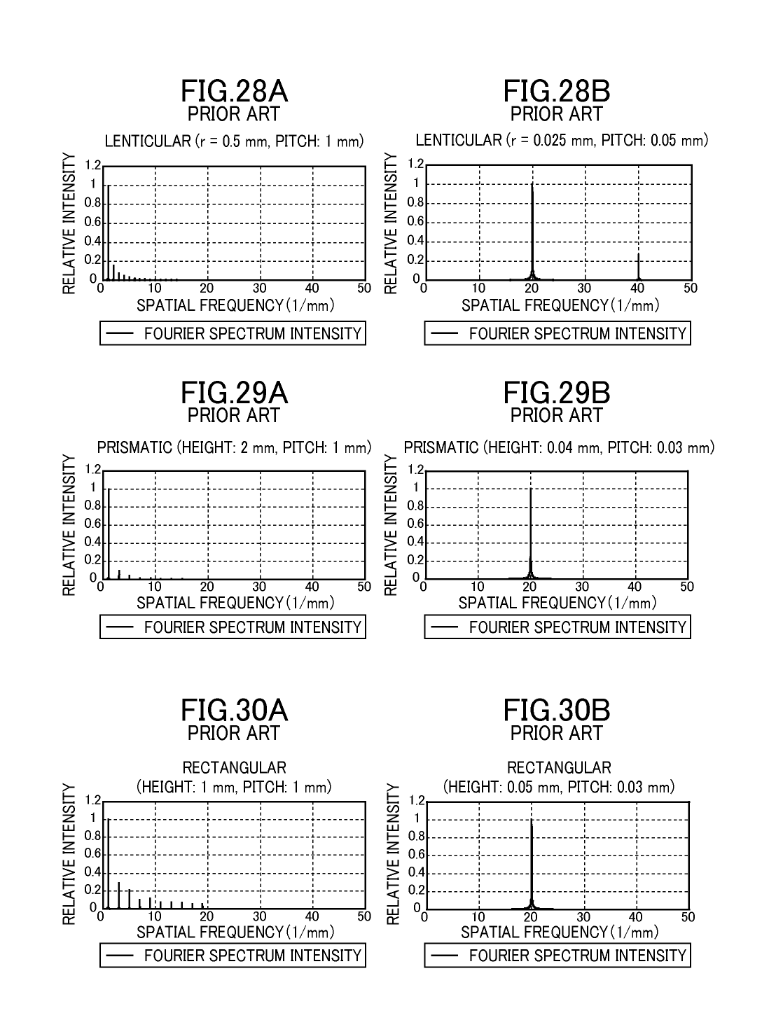

An example of the measurement results of the surface roughness of the cut and polished surface formed as the light incidence surface of the light guide plate of the invention is shown in FIGS. 12A and 12B; and examples of a lenticular structure, a prismatic structure and a rectangular groove structure conventionally provided in the light incidence surfaces of the light guide plates in order to suppress the luminance unevenness of light emitted through the light exit surface are shown in FIGS. 28A to 30B.

FIG. 12A is a diagram showing the measurement results of the surface roughness of the cut and polished surface 66 formed as the light incidence surface of the light guide plate 30 of the backlight unit 20 shown in FIG. 7A, as measured in the direction parallel to the longitudinal direction of the light incidence surface; and FIG. 12B is a diagram showing the surface roughness of FIG. 12A after conversion to Fourier spectrum. In FIG. 12A, the vertical axis indicates the surface roughness (mm) and the horizontal axis indicates the position (mm) on the light incidence surface of the light guide plate; and in FIG. 12B, the vertical axis indicates the relative intensity with respect to the surface roughness peak value and the horizontal axis indicates the spatial frequency (mm⁻¹).

Exemplary Fourier spectra of the lenticular structures conventionally provided in the light incidence surface of the light guide plate to suppress the luminance unevenness of light emitted through the light exit surface are shown in FIGS. 28A and 28B; exemplary Fourier spectra of the prismatic structures conventionally provided in the light incidence surface of the light guide plate to suppress the luminance unevenness of light emitted through the light exit surface are shown in FIGS. 29A and 29B; and exemplary Fourier spectra of the rectangular groove structures conventionally provided in the light incidence surface of the light guide plate to suppress the luminance unevenness of light emitted through the light exit surface are shown in FIGS. 30A and 30B.

The lenticular structure of which the Fourier spectrum is shown in FIG. 28A has such a shape that projections having their tops extending in the direction perpendicular to the light exit surface are periodically formed in the longitudinal direction of the light incidence surface. The projections each have a cross-sectional shape of a semicircle with a radius of 0.5 mm and are formed at a pitch of 1 mm.

The lenticular structure of which the Fourier spectrum is shown in FIG. 28B has such a shape that projections having their tops extending in the direction perpendicular to the light exit surface are periodically formed in the longitudinal direction of the light incidence surface. The projections each have a cross-sectional shape of a semicircle with a radius of 0.025 mm and are formed at a pitch of 0.05 mm.

The prismatic structure of which the Fourier spectrum is shown in FIG. 29A has such a shape that projections having their tops extending in the direction perpendicular to the light exit surface are periodically formed in the longitudinal direction of the light incidence surface. The projections each have a cross-sectional shape of a triangle with a height of 2 mm and are formed at a pitch of 1 mm.

The prismatic structure of which the Fourier spectrum is shown in FIG. 29B has such a shape that projections having their tops extending in the direction perpendicular to the light exit surface are periodically formed in the longitudinal direction of the light incidence surface. The projections each have a cross-sectional shape of a triangle with a height of 0.04 mm and are formed at a pitch of 0.03 mm.

The rectangular groove structure of which the Fourier spectrum is shown in FIG. 30A has such a shape that projections having their tops extending in the direction perpendicular to the light exit surface are periodically formed in the longitudinal direction of the light incidence surface. The projections each have a cross-sectional shape of a rectangle with a height of 1 mm and are formed at a pitch of 1 mm.

The rectangular groove structure of which the Fourier spectrum is shown in FIG. 30B has such a shape that projections having their tops extending in the direction perpendicular to the light exit surface are periodically formed in the longitudinal direction of the light incidence surface. The projections each have a cross-sectional shape of a rectangle with a height of 0.05 mm and are formed at a pitch of 0.03 mm.

The lenticular and prismatic structures conventionally provided in the light incidence surface to suppress the luminance unevenness in the vicinity of the light incidence surface are expressed by discrete spectra as shown in FIG. 28A to FIG. 30B. The structures expressed by such discrete spectra are directional and incident light can be advantageously diffused while reducing the luminance unevenness of light emitted through the light exit surface.

However, as described above, in cases where the light incidence surface has a lenticular or prismatic structure formed therein, the distance between the light source and the light incidence surface of the light guide plate relatively increases with decreasing thickness of the light guide plate, thus reducing the light incidence efficiency. Therefore, the lenticular or prismatic structure is to be reduced in size but is difficult to manufacture and also increases the cost.

In contrast, according to the light guide plate 30 of the invention, as shown in FIG. 12B, the envelope shape of the Fourier spectrum of the cut and polished surface 66 formed as the light incidence surface 30d shows a continuous spectrum but has a pointed top. Therefore, the cut and polished surface is directional as in the lenticular and prismatic structures, and incident light can be advantageously diffused while reducing the luminance unevenness of light emitted through the light exit surface 30a.

In addition, since the asperities of the cut and polished surface 66 are minute as compared to the lenticular and prismatic structures, the distance between the light incidence surface 30c of the light guide plate 30 and the light source unit 28 can be reduced to maintain and improve the light use efficiency.

Machining can be used as the method of forming the cut and polished surfaces 66 each having the periodic structure as the light incidence surfaces 30c and 30d of the light guide plate 30. More specifically, a two-layer light guide plate in plate form containing scattering particles at different particle concentrations is formed into the light guide plate 30 having the light incidence surfaces 30c and 30d each of which is not provided with the cut and polished surface 66 (roughened surface); the light incidence surfaces 30c and 30d which are not roughened are subjected to machining to enable the formation of the cut and polished surfaces 66. An example of such machining that may be used includes hairline finish in which a large number of minute and uneven lines are formed on the machined surface using, for example, a brush or a file. Alternatively, the movement speed and the rotation speed of the blade in a machine tool such as a milling machine, an NC router or a planer may be adjusted to control the period of contact between the unroughened light incidence surface 30c (30d) of the light guide plate 30 and the blade of the machine tool, thereby subjecting the unroughened light incidence surface 30c (30d) of the light guide plate 30 to machining for forming the cut and polished surface 66 having the periodic structure using the blade of the machine tool.

The method of manufacturing the light guide plate of the invention based on hairline finish or machining for forming the cut and polished surface as the light incidence surface of the light guide plate by controlling the period of contact between the blade of a machine tool and the light incidence surface facilitates the manufacture as compared to the conventional method of manufacturing the light guide plate which involves forming a lenticular or prismatic microstructure, and thus leads to cost reduction.

The pitch of the periodic structure of the cut and polished surface 66 is preferably sufficiently larger than the wavelength of visible light (λ=650 nm), that is, larger than 5 to 6 μm, and up to one-tenth of the length b of each of the LED chips 50 in the longitudinal direction of the light incidence surface.

In consideration of the combination with the light guide plate with a thickness of 2 mm or less, the LED chip for use as the light source of the side-lit backlight unit as in this invention preferably has a length “a” in the direction perpendicular to the light exit surface as expressed by the formula: a≦0.7 T (T: thickness of the light guide plate) in view of incidence efficiency. The light-emitting face of each of commercially available LED chips has an aspect ratio of about 1 to 3. Therefore, the LED chip preferably has a length “b” in the array direction of about 2 to 4 mm. Accordingly, the periodic structure of the cut and polished surface 66 preferably has a pitch of up to 0.4 mm.

The root-mean-square slope of the periodic structure of the cut and polished surface 66 is preferably in a range of 0.25 to 4.5.

When the surface roughness of the cut and polished surface 66 is small, incident light cannot be sufficiently diffused. On the other hand, when the surface roughness of the cut and polished surface 66 is too large, incidence light is more likely to cause Fresnel reflection to reduce the incidence efficiency by contraries, thus leading to reduction of the light use efficiency as seen from the whole of the light guide plate.

Incident light is thus diffused within a suitable range in the longitudinal direction of each of the light incidence surfaces 30c and 30d by adjusting the surface roughness of the cut and polished surface 66 in the above-defined range and hence light can be prevented from being diffused insomuch that light cannot reach the deep area of the light guide plate 30.

In the light guide plate 30 shown in FIG. 2, light emitted from the light source units 28 and allowed to enter the light guide plate 30 through the first light incidence surface 30c and the second light incidence surface 30d is scattered by scatterers (scattering particles) contained inside the light guide plate 30 as it travels through the inside of the light guide plate 30, and is emitted through the light exit surface 30a directly or after having been reflected by the rear surface 30b. Then, part of light may leak through the rear surface 30b but the light which leaked out is then reflected by a reflector 34 disposed on the side of the light guide plate 30 closer to the rear surface 30b to enter the light guide plate 30 again. The reflector 34 will be described later in detail.

The particle concentration Npo of the scattering particles in the first layer 60 and the particle concentration Npr of the scattering particles in the second layer 62 preferably satisfy the relationships of 0 wt %<Npo<0.15 wt % and Npo<Npr<0.8 wt %.

If the first layer 60 and the second layer 62 of the light guide plate 30 satisfy the above relationships, the light guide plate 30 can guide the incident light to the inside (center) of the light guide plate 30 without scattering it so much in the first layer 60 having a lower particle concentration, and the light is scattered by the second layer having a higher particle concentration as it approaches the center of the light guide plate, thus enabling the amount of light emitted through the light exit surface 30a to be increased. In brief, the illuminance distribution which is high in the middle at a preferable ratio can be obtained while further enhancing the light use efficiency.

The particle concentration [wt %] as used herein denotes a ratio of the weight of the scattering particles to the weight of the base material.

Alternatively, the particle concentration Npo of the scattering particles in the first layer 60 and the particle concentration Npr of the scattering particles in the second layer 62 preferably satisfy the relationships of Npo=0 wt % and 0.01 wt %<Npr<0.8 wt %. In other words, the light guide plate 30 may be configured such that the scattering particles are not dispersed in the first layer 60 by kneading so as to guide incident light deep into the light guide plate 30, and the scattering particles are only kneaded and dispersed in the second layer 62 to scatter the light more as it comes closer to the center of the light guide plate, thereby increasing the amount of light emitted through the light exit surface 30a.

Since the first layer 60 and the second layer 62 of the light guide plate 30 satisfy the above relationships, the illuminance distribution which is high in the middle at a preferable ratio can be obtained while further enhancing the light use efficiency.

Polydisperse particles including a mixture of particles with different particle sizes can be used as scattering particles to be kneaded and dispersed in the light guide plate 30.

In general, monodisperse particles which are uniform in particle size are more preferably used as the scattering particles to be kneaded and dispersed in the light guide plate than polydisperse particles because light is scattered more uniformly inside the light guide plate, the light use efficiency can be improved, and the color unevenness is less likely to occur. However, classification of the particles is necessary to obtain the monodisperse particles, which may increase costs.

In contrast, even in cases where polydisperse particles including a mixture of particles with different particle sizes are used, the invention can prevent the light use efficiency from being reduced by incorporating the scattering particles at particle concentrations which are different from region to region inside the light guide plate 30. Therefore, classification of the scattering particles is not necessary, which enables cost reduction.

In the invention, particles satisfying a Gaussian distribution in which the distribution of the particle size with respect to the central particle size falls within a range of ±0.5 μm when calculated as 3σ, where σ represents the standard deviation of the particle size of the scattering particles, are referred to as monodisperse particles, and the other particles are referred to as polydisperse particles.

The thickness of the light guide plate of the invention is not particularly limited. The light guide plate may be several millimeters in thickness or may be a so-called light guide sheet which is a film with a thickness of 1 mm or less. A film-like light guide plate having two layers which contain scattering particles kneaded and dispersed therein at different particle concentrations may be produced by a method which involves forming as the first layer a base film containing scattering particles by extrusion molding or other process, applying a monomer resin liquid (transparent resin liquid) having scattering particles dispersed therein to the formed base film, and exposing the base film to ultraviolet light or visible light to cure the monomer resin liquid to thereby form the second layer having a desired particle concentration, thus producing the film-like light guide plate. Alternatively, the film-like light guide plate may be produced by two-layer extrusion molding.

Also in cases where the light guide plate is a film-like light guide sheet with a thickness of 1 mm or less, formation of the light guide plate with two layers enables the illuminance distribution which is high in the middle at a preferable ratio to be obtained while further enhancing the light use efficiency.

In the illustrated light guide plate 30, the interface z has such a shape as to form a curved surface which is concave toward the light exit surface 30a in each of the regions from the positions of the first local maximum value to their corresponding light incidence surfaces 30c and 30d, and which communicates with ends of the light incidence surfaces 30c and 30d closer to the rear surface 30b. However, the invention is not limited thereto.

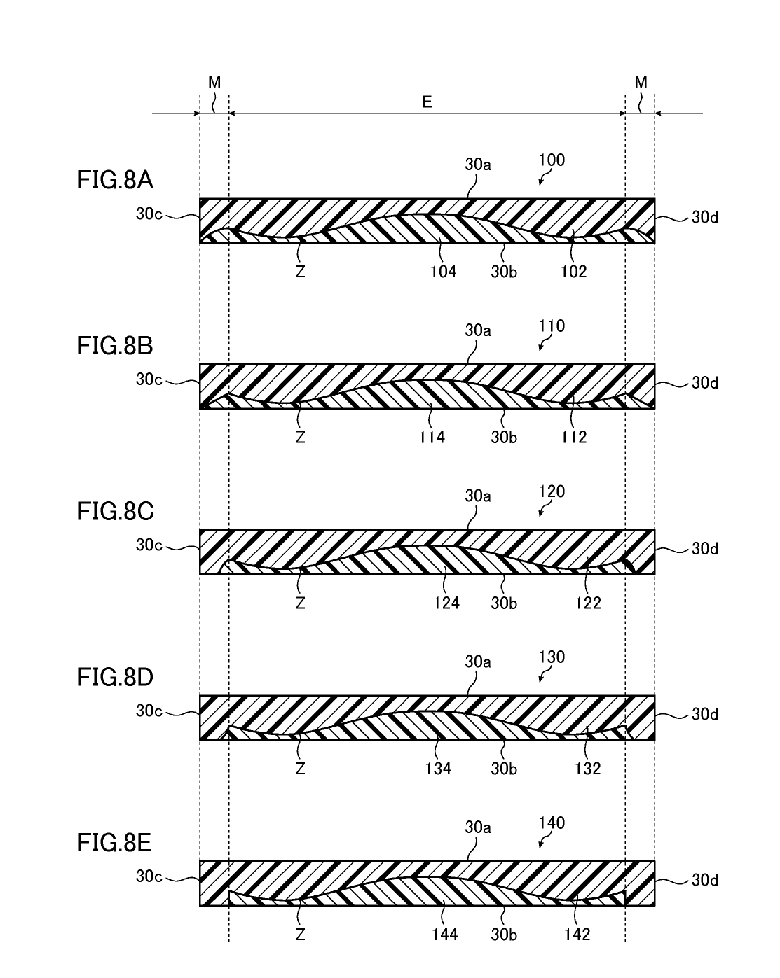

FIGS. 8A to 8E are schematic views showing other examples of the light guide plate of the invention.

Each of light guide plates 100, 110, 120, 130 and 140 shown in FIGS. 8A to 8E has the same configuration as the light guide plate 30 shown in FIG. 3B except that the thickness of each of the first and second layers in the mixing zones M, that is, the shape of the interface z in the portions from the light incidence surfaces 30c and 30d to the positions of the first local maximum value is changed. Therefore, like elements are denoted by the same reference numerals and the following description mainly focuses on the distinctive portions.

The light guide plate 100 shown in FIG. 8A includes a first layer 102 and a second layer 104 having a higher particle concentration than the first layer 102. In mixing zones M, an interface z between the first layer 102 and the second layer 104 has such a shape as to include curved surfaces which communicate with the positions of a first local maximum value, are convex toward a light exit surface 30a, and communicate with ends of light incidence surfaces 30c and 30d closer to a rear surface 30b.

The light guide plate 110 shown in FIG. 8B includes a first layer 112 and a second layer 114 having a higher particle concentration than the first layer 112. In mixing zones M, an interface z between the first layer 112 and the second layer 114 includes flat surfaces connecting the positions of a first local maximum value to ends of light incidence surfaces 30c and 30d closer to a rear surface 30b.

The light guide plate 120 shown in FIG. 8C includes a first layer 122 and a second layer 124 having a higher particle concentration than the first layer 122. In mixing zones M, an interface z between the first layer 122 and the second layer 124 has such a shape as to include curved surfaces which communicate with the positions of a first local maximum value, are convex toward a light exit surface 30a, and communicate with a rear surface 30b substantially in the middle of the mixing zones M.

The light guide plate 130 shown in FIG. 8D includes a first layer 132 and a second layer 134 having a higher particle concentration than the first layer 132. In mixing zones M, an interface z between the first layer 132 and the second layer 134 has such a shape as to include curved surfaces which communicate with the positions of a first local maximum value, are concave toward a light exit surface 30a, and communicate with a rear surface 30b substantially in the middle of the mixing zones M.

The light guide plate 140 shown in FIG. 8E includes a first layer 142 and a second layer 144 having a higher particle concentration than the first layer 142. In mixing zones M, the light guide plate 140 only includes the first layer 142. In other words, an interface z has such a shape as to include flat surfaces passing through the positions of a first local maximum value and parallel to light incidence surfaces 30c and 30d.

By forming the interface z so as to have such a shape that the second layer decreases in thickness from the positions of the first local maximum value toward the light incidence surfaces 30c and 30d as in the light guide plates shown in FIGS. 8A to 8E, the regions from the positions of the first local maximum value to the light incidence surfaces 30c and 30d (mixing zones M) can be adjusted to have a lower combined particle concentration than the first local maximum value to reduce return light, which is light outgoing through the light incidence surfaces after it once enters the light guide plate, and outgoing light from the regions in the vicinities of the light incidence surfaces (mixing zones M) which is not used because the regions are covered with the housing, whereupon the use efficiency of outgoing light through the effective region of the light exit surface (effective screen area E) can be improved.

In a cross section perpendicular to the longitudinal direction of the light incidence surface, the concave and convex curves which form the interface z may be curves expressed by part of a circle or an ellipse, quadratic curves, curves expressed by polynomials, or curves obtained by combination thereof.

The illustrated embodiment is configured in such a way that the thickness of the second layer containing scattering particles at a higher particle concentration than that in the first layer 60 is continuously changed so that the second layer has the first local maximum value as a result of an increased thickness in the vicinities of the light incidence surfaces and the second local maximum value at the central portion of the light guide plate having the largest thickness, whereby the combined particle concentration of the scattering particles is changed so as to have the first local maximum value in the vicinity of each of the first and second light incidence surfaces and the second local maximum value at the central portion of the light guide plate, the second local maximum value being larger than the first local maximum value. However, the invention is not limited to this and the backlight unit may be configured such that the first local maximum value of the combined particle concentration is positioned on the light incidence surfaces, that is, the profile of the combined particle concentration may have a curve which changes so as to have the second local maximum value that is the largest at the central portion of the light guide plate and the local minimum value on both sides thereof.

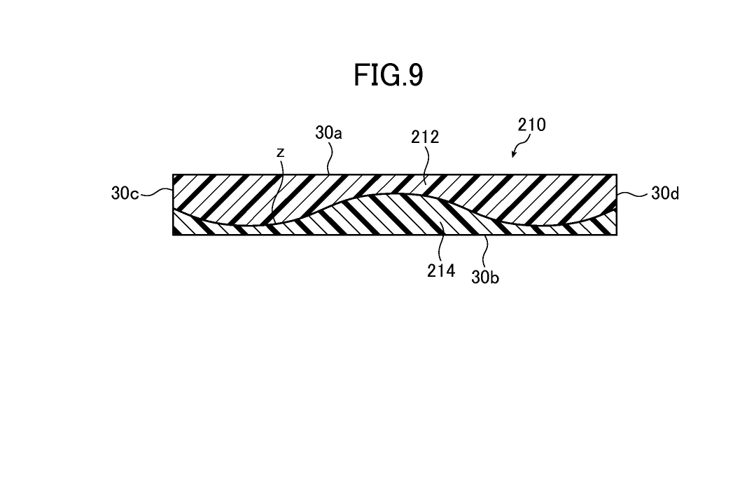

FIG. 9 is a schematic cross-sectional view showing another example of the light guide plate of the invention.

A light guide plate 210 shown in FIG. 9 has the same configuration as the light guide plate 30 shown in FIG. 3A except that the shape of the interface z between the first layer and the second layer is changed. Therefore, like elements are denoted by the same reference numerals and the following description mainly focuses on the distinctive portions.

The light guide plate 210 shown in FIG. 9 includes a first layer 212 on the side closer to a light exit surface 30a and a second layer 214 having a higher particle concentration than the first layer 212 and located on the side closer to a rear surface 30b. The shape of an interface z between the first layer 212 and the second layer 214 changes so that the thickness of the second layer 214 is the largest at the central portion of the light guide plate and decreases from the central portion toward light incidence surfaces 30c and 30d, and then continuously changes so that the thickness of the second layer 214 increases again in the vicinities of the light incidence surfaces 30c and 30d.

More specifically, the interface z includes a curved surface convex toward the light exit surface 30a at the central portion of the light guide plate 210, and concave curved surfaces smoothly connected to the convex curved surface and communicating with the light incidence surfaces 30c and 30d.

More specifically, the profile of the combined particle concentration has a curve which has the second local maximum value that is the largest at the center of the light guide plate and which changes on both sides so as to have the local minimum value at positions away by about two-thirds of the distance from the center to the light incidence surfaces in the illustrated example.

The backlight unit is thus configured such that the thickness of the second layer having a higher particle concentration is the largest at the central portion of the light guide plate, changes so as to decrease from the central portion toward the light incidence surfaces and then continuously changes so as to increase again in the vicinities of the light incidence surfaces, in other words, such that the combined particle concentration is continuously changed so as to once decrease from the light incidence surfaces toward the central portion of the light guide plate and then increase to have the highest value at the central portion of the light guide plate. With this configuration, light having entered through the light incidence surfaces can travel to positions farther from the light incidence surfaces even in a large and thin light guide plate, whereby outgoing light may have a luminance distribution which is high in the middle.

By setting the combined particle concentration in the vicinities of the light incidence surfaces to be higher than the local minimum value, light having entered through the light incidence surfaces can be sufficiently diffused in the vicinities of the light incidence surfaces to prevent outgoing light from the vicinities of the light incidence surfaces from having visible bright lines (dark lines, unevenness) which are attributable to such causes as intervals at which the light sources are disposed.

Although not shown, even in the light guide plate 210, each of the light incidence surfaces 30c and 30d is formed so as to have a cut and polished surface having a given periodic structure in a direction parallel to the longitudinal direction of each of the light incidence surfaces, and the luminance unevenness due to spaces between the adjacent LED chips 50 can be reduced.

The light exit surface 30a is flat in the illustrated examples. However, this is not the sole case and the light exit surface 30a may be concave. The light exit surface 30a having a concave shape can prevent the light guide plate from warping toward the light exit surface side upon expansion or contraction of the light guide plate due to heat and humidity, thus from touching the liquid crystal display panel 12.

The rear surface 30b is flat in the illustrated examples. However, this is not the sole case and the rear surface may be a concave surface, that is, a surface inclined in directions in which the thickness decreases with increasing distance from the light incidence surfaces. Alternatively, the rear surface may be a convex surface, that is, a surface inclined in directions in which the thickness increases with increasing distance from the light incidence surfaces.

Next, the optical member unit 32 will be described.

The optical member unit 32 is provided to reduce the luminance unevenness and illuminance unevenness of illumination light emitted through the light exit surface 30a of the light guide plate 30 before emitting the light through the light exit surface 24a of the lighting device main body 24. As shown in FIG. 2, the optical member unit 32 includes a diffusion sheet 32a for diffusing the illumination light emitted through the light exit surface 30a of the light guide plate 30 to reduce the luminance unevenness and illuminance unevenness; a prism sheet 32b having microprism arrays formed thereon parallel to the lines where the light exit surface 30a and the light incidence surfaces 30c, 30d meet; and a diffusion sheet 32c for diffusing the illumination light emitted through the prism sheet 32b to reduce the luminance unevenness and the illuminance unevenness.

There is no particular limitation on the diffusion sheets 32a and 32c and the prism sheet 32b and known diffusion sheets and prism sheets may be used. For example, use may be made of the diffusion sheets and the prism sheets disclosed in paragraphs [0028] through [0033] of commonly assigned JP 2005-234397 A.

While the optical member unit in the embodiment under discussion includes the two diffusion sheets 32a and 32c and the prism sheet 32b disposed between the two diffusion sheets, there is no particular limitation on the order in which the prism sheet and the diffusion sheets are arranged or the number of the sheets to be used. The materials of the prism sheet and the diffusion sheets are also not particularly limited, and use may be made of various optical members, as long as they can further reduce the unevenness in luminance and illuminance of the illumination light emitted through the light exit surface 30a of the light guide plate 30.

For example, the optical members used in addition to or instead of the above-described diffusion sheets and prism sheet may be transmittance adjusting members in which a large number of transmittance adjusters consisting of diffusion reflectors are disposed according to the luminance unevenness and the illuminance unevenness. Further, the optical member unit may be of a two-layer structure including one prism sheet and one diffusion sheet or including two diffusion sheets only.

Next, the reflector 34 of the lighting device main body 24 will be described.

The reflector 34 is provided to reflect light leaking through the rear surface 30b of the light guide plate 30 back into the light guide plate 30 and helps enhance the light use efficiency. The reflector 34 has a shape corresponding to the rear surface 30b of the light guide plate 30 and is formed so as to cover the rear surface 30b. In this embodiment, the reflector 34 is formed into a shape contouring the profile of the rear surface 30b of the light guide plate 30 having a flat plane, that is, having a linear shape in cross section as shown in FIG. 2.

The reflector 34 may be formed of any material, as long as it can reflect light leaking through the rear surface 30b of the light guide plate 30. The reflector 34 may be formed, for example, of a resin sheet produced by kneading a filler with PET or PP (polypropylene) and then drawing the resultant mixture to form voids therein for increased reflectance; a sheet with a specular surface formed by, for example, aluminum vapor deposition on the surface of a transparent or white resin sheet; a metal foil such as an aluminum foil or a resin sheet carrying a metal foil; or a thin metal sheet having sufficient reflectivity on the surface.

Upper light guide reflectors 36 are disposed between the light guide plate 30 and the diffusion sheet 32a, i.e., on the side closer to the light exit surface 30a of the light guide plate 30, so as to cover the light source units 28 and the end portions of the light exit surface 30a of the light guide plate 30 (i.e., the end portion on the side closer to the first light incidence surface 30c and the end portion on the side closer to the second light incidence surface 30d). In other words, each upper light guide reflector 36 is disposed so as to cover an area extending from part of the light exit surface 30a of the light guide plate 30 to part of the light source support 52 of the light source unit 28 in a direction parallel to the direction of the optical axis. Briefly, the two upper light guide reflectors 36 are disposed at both end portions of the light guide plate 30, respectively.

By thus providing the upper light guide reflectors 36, light emitted from the light source units 28 can be prevented from failing to enter the light guide plate 30 and leaking on the side of the light exit surface 30a.

Thus, light emitted from the light source units 28 can efficiently enter the light guide plate 30 through the first light incidence surface 30c and the second light incidence surface 30d of the light guide plate 30 to enhance the light use efficiency.

Lower light guide reflectors 38 are disposed on the side closer to the rear surface 30b of the light guide plate 30 so as to cover part of the light source units 28. Ends of the lower light guide reflectors 38 closer to the center of the light guide plate 30 are connected to the reflector 34.

The upper light guide reflectors 36 and the lower light guide reflectors 38 may be formed of any of the above-mentioned various materials used to form the reflector 34.

By providing the lower light guide reflectors 38, light emitted from the light source units 28 can be prevented from failing to enter the light guide plate 30 and leaking on the side of the rear surface 30b of the light guide plate 30.

Thus, light emitted from the light source units 28 can efficiently enter the light guide plate 30 through the first light incidence surface 30c and the second light incidence surface 30d of the light guide plate 30 to enhance the light use efficiency.

While the reflector 34 is connected to the lower light guide reflectors 38 in the embodiment under discussion, this is not the sole case and they may be used as separate members.

The shapes and the widths of the upper light guide reflectors 36 and the lower light guide reflectors 38 are not particularly limited as long as light emitted from the light source units 28 can be reflected toward and allowed to enter through the first light incidence surface 30c and the second light incidence surface 30d and the light having entered the light guide plate 30 can be guided to the central side of the light guide plate 30.

In the embodiment under discussion, the upper light guide reflectors 36 are disposed between the light guide plate 30 and the diffusion sheet 32a. However, the upper light guide reflectors 36 may be disposed at any position without particular limitation. It may be disposed between the sheet members constituting the optical member unit 32 or between the optical member unit 32 and the upper housing 44.

Next, the housing 26 will be described.

As shown in FIG. 2, the housing 26 accommodates and supports the lighting device main body 24 and holds and secures the lighting device main body 24 from the side closer to the light exit surface 24a and the side closer to the rear surface 30b of the light guide plate 30. The housing 26 includes the lower housing 42, the upper housing 44, the bent members 46 and the support members 48.

The lower housing 42 is open at the top and has a shape formed by a bottom section and lateral sections provided upright on the four sides of the bottom section. In brief, it is substantially in the shape of a rectangular box open on one side. As shown in FIG. 2, the lower housing 42 supports the lighting device main body 24 placed therein from above on the bottom section and the lateral sections and covers the faces of the lighting device main body 24 except the light exit surface 24a, i.e., the face opposite from the light exit surface 24a of the lighting device main body 24 (rear surface) and the lateral faces.

The upper housing 44 has the shape of a rectangular box; it has at the top a rectangular opening which is smaller than the rectangular light exit surface 24a of the lighting device main body 24 and is open at the bottom.

As shown in FIG. 2, the upper housing 44 is placed from above the lighting device main body 24 and the lower housing 42 (from the light exit surface side) to cover the lighting device main body 24 and the lower housing 42 holding the main body therein, including the four lateral sections.

The bent members 46 have a concave (U-shaped) sectional profile that is always identical throughout their length. That is, each bent member 46 is a bar-shaped member having a U-shaped profile in cross section perpendicular to the direction in which they extends.

As shown in FIG. 2, the bent members 46 are fitted between the lateral faces of the lower housing 42 and the lateral faces of the upper housing 44 such that the outer face of one of the parallel sections of the U-shaped member is connected with the lateral section of the lower housing 42 whereas the outer face of the other parallel section is connected with the lateral section of the upper housing 44.

Various known methods including a method using bolts and nuts and a method using an adhesive may be used to join the lower housing 42 to the bent members 46 and the bent members 46 to the upper housing 44.

By thus providing the bent members 46 between the lower housing 42 and the upper housing 44, the rigidity of the housing 26 can be increased to prevent the light guide plate 30 from warping. As a result, for example, light having no or reduced luminance unevenness and illuminance unevenness can be efficiently emitted. Further, even in cases where the light guide plate used is liable to warp, the warp can be corrected more reliably or the warping of the light guide plate can be prevented more reliably, thereby allowing light having no or reduced luminance unevenness and illuminance unevenness to be emitted through the light exit surface.

Various materials such as metals and resins may be used to form the upper housing, the lower housing and the bent members of the housing. The material used is preferably light in weight and very strong.

While the bent members are provided as separate members in the embodiment under discussion, they may be integrated with the upper housing or the lower housing. Alternatively, the housing may not have the bent members.

The support members 48 are rod members each having an identical shape in cross section perpendicular to the direction in which they extend.

As shown in FIG. 2, the support members 48 are provided between the reflector 34 and the lower housing 42, more specifically, between the reflector 34 and the lower housing 42 at positions corresponding to the ends of the rear surface 30b of the light guide plate 30 on the sides closer to the first light incidence surface 30c and the second light incidence surface 30d, respectively. The support members 48 thus secure the light guide plate 30 and the reflector 34 to the lower housing 42 and support them.

The light guide plate 30 can be brought into close contact with the reflector 34 by supporting the reflector 34 with the support members 48. Furthermore, the light guide plate 30 and the reflector 34 can be secured to the lower housing 42 at predetermined positions.

While the support members are provided as separate members in the embodiment under discussion, the invention is not limited thereto and they may be integrated with the lower housing 42 or the reflector 34. To be more specific, projections may be formed in part of the lower housing 42 to serve as support members or projections may be formed in part of the reflector 34 to serve as support members.

The location of the support members is also not particularly limited and they may be provided at any positions between the reflector and the lower housing. To stably hold the light guide plate, the support members are preferably provided on the end sides of the light guide plate, that is, near the first light incidence surface 30c and the second light incidence surface 30d in the embodiment under discussion.

The shape of the support members 48 is not particularly limited and the support members 48 may have any of various shapes. The support members 48 may also be formed of various materials. For example, a plurality of support members may be provided at predetermined intervals.

Further, the support members may have such a shape as to fill the whole space formed by the reflector and the lower housing. More specifically, the support members may have a surface shape contouring the profile of the reflector on the reflector side and a surface shape contouring the profile of the lower housing on the lower housing side. In cases where the whole surface of the reflector is thus supported by the support members, the reflector can be reliably prevented from being separated from the light guide plate, and light reflected by the reflector can be prevented from causing luminance unevenness and illuminance unevenness.

The operation of the backlight unit 20 configured as above will now be described.

In the backlight unit 20, light emitted from the light source units 28 provided on both ends of the light guide plate 30 enters through the light incidence surfaces (the first light incidence surface 30c and the second light incidence surface 30d) of the light guide plate 30. The incident light through the respective surfaces is scattered by scatterers contained inside the light guide plate 30 as the light travels inside the light guide plate 30 and is emitted through the light exit surface 30a directly or after being reflected by the rear surface 30b. Then, part of the light leaking through the rear surface is reflected by the reflector 34 to enter the light guide plate 30 again.

Light thus emitted through the light exit surface 30a of the light guide plate 30 is transmitted through the optical member unit 32 and emitted through the light exit surface 24a of the lighting device main body 24 to illuminate the liquid crystal display panel 12.

The liquid crystal display panel 12 uses the drive unit 14 to control the light transmittance according to the position so as to display characters, figures, images, etc. on the surface of the liquid crystal display panel 12.

Although each of the light guide plates according to the above embodiments is of a type comprising two light source units disposed on two light incidence surfaces so that light enters from both sides of the light guide plate, the invention is not limited thereto; the light guide plate may be of a type comprising only one light source unit disposed on one light incidence surface so that light enters from one side of the light guide plate. Reduction in number of light source units enables the number of parts and hence the costs to be reduced.

In cases where light is allowed to enter from one side of the light guide plate, the interface z may have an asymmetric shape. For example, the light guide plate may have one light incidence surface and include a second layer which has such an asymmetric shape that the second layer has a maximum thickness at a position far from the light incidence surface beyond the bisector of the light exit surface.

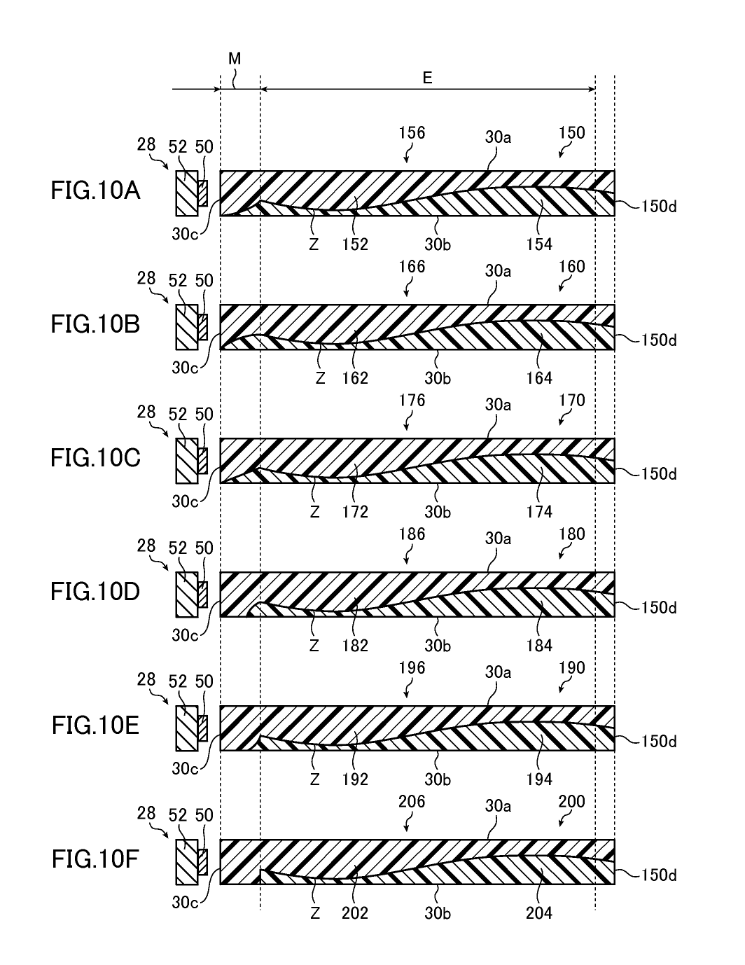

FIG. 10A is a schematic cross-sectional view showing part of a backlight unit using another example of the inventive light guide plate. Since a backlight unit 156 shown in FIG. 10A has the same configuration as the backlight unit 20 except that the light guide plate 30 is replaced by a light guide plate 150 and only one light source unit 28 is used, like elements are denoted by the same reference numerals and the following description mainly focuses on the distinctive portions.

The backlight unit 156 shown in FIG. 10A includes the light guide plate 150 and the light source unit 28 disposed so as to face a first light incidence surface 30c of the light guide plate 150.

The light guide plate 150 includes the first light incidence surface 30c facing the disposed light source unit 28 and a lateral surface 150d opposite from the first light incidence surface 30c.

The light guide plate 150 includes a first layer 152 on the side closer to a light exit surface 30a and a second layer 154 on the side closer to a rear surface 30b. When seen in the cross section perpendicular to the longitudinal direction of the first light incidence surface 30c, an interface z between the first layer 152 and the second layer 154 continuously changes so that the second layer 154 increases in thickness from the first light incidence surface 30c toward the lateral surface 150d, then once decreases in thickness, then increases in thickness again and subsequently decreases in thickness on the side closer to the lateral surface 150d.

More specifically, the interface z includes a curved surface convex toward the light exit surface 30a on the side closer to the lateral surface 150d, a concave curved surface smoothly connected to the convex curved surface, and a concave curved surface connected to the concave curved surface and communicating with one end of the light incidence surface 30c on the side closer to the rear surface 30b. The thickness of the second layer 154 at the light incidence surface 30c is zero.

More specifically, the combined particle concentration of the scattering particles (thickness of the second layer) is changed so as to have the first local maximum value in the vicinity of the first light incidence surface 30c and the second local maximum value on the side closer to the lateral surface 150d beyond the central portion of the light guide plate, the second local maximum value being larger than the first local maximum value.

Although not shown, the combined particle concentration of the light guide plate 150 has the first local maximum value at the edge of the opening of the housing and the region from the light incidence surface 30c to the position of the first local maximum value is a so-called mixing zone M for diffusing light having entered through the light incidence surface.

In the case of one-side light incidence using only one light source unit, the combined particle concentration of the light guide plate 150 (thickness of the second layer 154) is adjusted so that the concentration has the first local maximum value at a position closer to the light incidence surface 30c and the second local maximum value which is larger than the first local maximum value on the side closer to the lateral surface 150d beyond the central portion. With this adjustment, light having entered through the light incidence surface can travel to a position farther from the light incidence surface even in a large and thin light guide plate, whereby outgoing light may have a luminance distribution which is high in the middle.

By adjusting the combined particle concentration so as to have the first local maximum value in the vicinity of the light incidence surface, light having entered through the light incidence surface can be sufficiently diffused in the vicinity of the light incidence surface to prevent outgoing light from the vicinity of the light incidence surface from having visible bright lines (dark lines, unevenness) which are attributable to such causes as intervals at which the light sources (LED chips) are disposed.

By adjusting the combined particle concentration so that the region on the side closer to the light incidence surface than the position where the combined particle concentration takes the first local maximum value has a lower combined particle concentration than the first local maximum value, return light, which is outgoing light through the light incidence surface after it once enters the light guide plate, and outgoing light from the region in the vicinity of the light incidence surface (mixing zone M), which is not used because the region is covered with the housing, can be reduced to improve the use efficiency of outgoing light through the effective region of the light exit surface (effective screen area E).

Although not shown, even in the light guide plate 150, the light incidence surface 30c is formed so as to have a cut and polished surface having a given periodic structure in a direction parallel to the longitudinal direction of the light incidence surface, and the luminance unevenness due to spaces between the adjacent LED chips can be reduced.

The interface z in the mixing zone M of the light guide plate 150 of the backlight unit 156 shown in FIG. 10A has such a shape as to include a curved surface which is concave toward the light exit surface 30a and communicates with an end of the light incidence surface 30c on the side closer to the rear surface 30b. However, the invention is not limited thereto.

FIGS. 10B to 10F are schematic views showing other examples of the light guide plate of the invention.

Each of backlight units 166, 176, 186, 196 and 206 shown in FIGS. 10B to 10F has the same configuration as the backlight unit 156 shown in FIG. 10A except that the thicknesses of the first layer 152 and the second layer 154 in the mixing zone M of the light guide plate 150, that is, the shape of the interface z in the portion from the light incidence surface 30c to the position of the first local maximum value is changed. Therefore, like elements are denoted by the same reference numerals and the following description mainly focuses on the distinctive portions.

A light guide plate 160 of the backlight unit 166 shown in FIG. 10B includes a first layer 162 and a second layer 164 having a higher particle concentration than the first layer 162. In a mixing zone M, an interface z between the first layer 162 and the second layer 164 has such a shape as to include a curved surface which communicates with the position of a first local maximum value, is convex toward a light exit surface 30a, and communicates with an end of a light incidence surface 30c on the side closer to a rear surface 30b.

A light guide plate 170 of the backlight unit 176 shown in FIG. 10C includes a first layer 172 and a second layer 174 having a higher particle concentration than the first layer 172. In a mixing zone M, an interface z between the first layer 172 and the second layer 174 includes a flat surface connecting the position of a first local maximum value to one end of a light incidence surface 30c on the side closer to a rear surface 30b.

A light guide plate 180 of the backlight unit 186 shown in FIG. 10D includes a first layer 182 and a second layer 184 having a higher particle concentration than the first layer 182. In a mixing zone M, an interface z between the first layer 182 and the second layer 184 has such a shape as to include a curved surface which communicates with the position of a first local maximum value, is convex toward a light exit surface 30a, and communicates with a rear surface 30b substantially in the middle of the mixing zone M.

A light guide plate 190 of the backlight unit 196 shown in FIG. 10E includes a first layer 192 and a second layer 194 having a higher particle concentration than the first layer 192. In a mixing zone M, an interface z between the first layer 192 and the second layer 194 has such a shape as to include a curved surface which communicates with the position of a first local maximum value, is concave toward a light exit surface 30a, and communicates with a rear surface 30b substantially in the middle of the mixing zone M.

A light guide plate 200 of the backlight unit 206 shown in FIG. 10F includes a first layer 202 and a second layer 204 having a higher particle concentration than the first layer 202. In a mixing zone M, the light guide plate 200 only includes the first layer 202. In other words, an interface z has such a shape as to include a flat surface passing through the position of a first local maximum value and parallel to a light incidence surface 30c.

By forming the interface z so as to have such a shape that the second layer decreases in thickness from the position of the first local maximum value toward the light incidence surface 30c as in the light guide plates shown in FIGS. 10B to 10F, the region from the position of the first local maximum value to the light incidence surface 30c (mixing zone M) can be adjusted to have a lower combined particle concentration than the first local maximum value to reduce return light, which is light outgoing through the light incidence surface after it once enters the light guide plate, and outgoing light from the region in the vicinity of the light incidence surface (mixing zone M) which is not used because the region is covered with the housing, whereupon the use efficiency of outgoing light through the effective region of the light exit surface (effective screen area E) can be improved.

In the backlight unit 156 shown in FIG. 10A, the combined particle concentration of the light guide plate 150 is adjusted so that the concentration has the first local maximum value at a position closer to the light incidence surface 30c and the second local maximum value which is larger than the first local maximum value on the side closer to the lateral surface 150d beyond the central portion. However, the invention is not limited to this, and the backlight unit 156 may be configured such that the first local maximum value is positioned on the light incidence surface, that is, the profile of the combined particle concentration may have a curve which changes so as to have a local minimum value at a position closer to the light incidence surface 30c and a second local maximum value on the side closer to the lateral surface 150d.

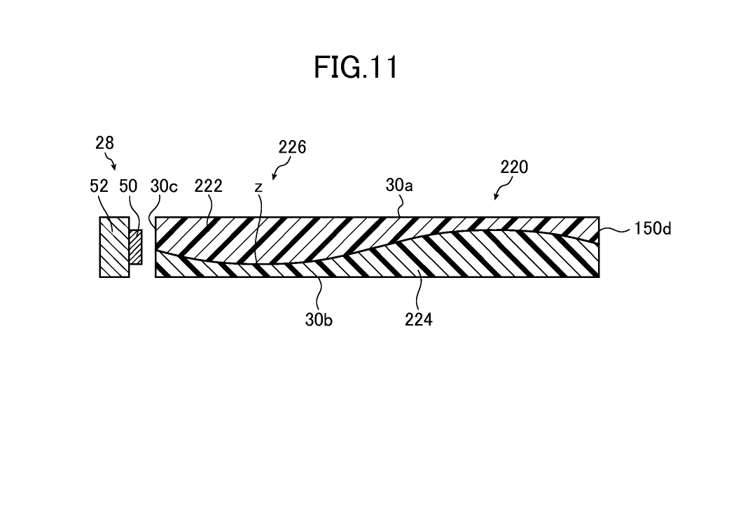

FIG. 11 is a schematic cross-sectional view showing a backlight unit using another example of the inventive light guide plate.

A backlight unit 226 shown in FIG. 11 has the same configuration as the backlight unit 156 shown in FIG. 10A except that the light guide plate 150 is replaced by a light guide plate 220 in which the shape of an interface z between a first layer 222 and a second layer 224 is changed. Therefore, like elements are denoted by the same reference numerals and the following description mainly focuses on the distinctive portions.

The backlight unit 226 shown in FIG. 11 includes the light guide plate 220 and a light source unit 28 disposed so as to face a light incidence surface 30c of the light guide plate 220.

The light guide plate 220 includes the first layer 222 on the side closer to a light exit surface 30a and the second layer 224 having a higher particle concentration than the first layer 222 and located on the side closer to a rear surface 30b. The shape of the interface z between the first layer 222 and the second layer 224 continuously changes so that the second layer 224 once decreases in thickness from the light incidence surface 30c toward a lateral surface 150d, then increases in thickness and decreases in thickness on the side closer to the lateral surface 150d.

More specifically, the interface z includes a concave curved surface toward the light exit surface 30a on the side closer to the light incidence surface 30c of the light guide plate 220 and a convex curved surface smoothly connected to the concave curved surface and positioned on the side closer to the lateral surface 150d.

In short, the profile of the combined particle concentration has a curve which changes so as to have a local minimum value on the side closer to the light incidence surface and a second local maximum value on the side closer to the lateral surface.

In the case of one-side light incidence using only one light source unit as described above, by thus adjusting the combined particle concentration of the light guide plate 220 (thickness of the second layer 224) so that the concentration has the local minimum value at a position closer to the light incidence surface 30c and the second local maximum value on the side closer to the lateral surface 150d beyond the central portion, light having entered through the light incidence surface can travel to a position farther from the light incidence surface even in a large and thin light guide plate, whereby outgoing light may have a luminance distribution which is high in the middle.

By adjusting the combined particle concentration in the vicinity of the light incidence surface so as to be higher than the local minimum value, light having entered through the light incidence surface can be sufficiently diffused in the vicinity of the light incidence surface to prevent outgoing light from the vicinity of the light incidence surface from having visible bright lines (dark lines, unevenness) which are attributable to such causes as intervals at which the light sources are disposed.

The illustrated embodiment is configured such that the thickness of the second layer 224 in the direction perpendicular to the light incidence surface 30c decreases from the position of the second local maximum value toward the lateral surface 150d. However, this is not the sole configuration but the illustrated embodiment may be configured such that the thickness is constant from the position of the second local maximum value to the lateral surface 150d.

The backlight unit using the light guide plate of the invention is not limited thereto and, in addition to the two light source units, light source units may also be provided so as to face the lateral surfaces on the short sides of the light exit surface of the light guide plate. The intensity of light emitted from the device can be enhanced by increasing the number of light source units.

Light may be emitted not only through the light exit surface but also from the rear surface side.

The light guide plate of the invention includes the two layers which contain scattering particles at different particle concentrations. However, the light guide plate is not limited thereto and may include three or more layers which are different in the scattering particle concentration.

### EXAMPLES

The invention will be described below in greater detail with reference to specific examples of the invention.

### Examples

The light guide plate of the invention will now be described more specifically by way of examples.

In Examples, a simulation was carried out using two-layer light guide plates of the shape shown in FIG. 3B by changing the surface average angle of inclination (°) of the cut and polished surface 66 formed as the light incidence surface (average of the absolute values of the angle of inclination at the respective positions) in increments of 5° in a range of 5° to 60°.

The thickness of each light guide plate was set to 2.0 mm; the particle concentration of the first layer to 0.005 wt %; the particle concentration of the second layer to 0.275 wt %; the distance from the light incidence surfaces to their corresponding positions of the first local maximum value to 10 mm; and the thickness of the second layer at the positions of the first local maximum value to 0.17 mm.

The distance from the positions of the first local maximum value to their corresponding positions of the local minimum value was set to 10 mm; and the thickness of the second layer at the positions of the local minimum value to 0.145 mm.

The distance from the light incidence surfaces to the position of the second local maximum value (center of the light guide plate) was set to 270 mm; and the thickness of the second layer at the position of the second local maximum value to 0.8 mm.

Measurement was performed by setting the length “b” in the direction in which the LED chips are arranged to 2.2 mm; the length “a” in the direction perpendicular to the light exit surface to 1.15 mm; and the distance “q” between adjacent LED chips to 10.5 mm.

FIGS. 12A to 23A (only A) are diagrams (graphs) showing the surface roughness of examples of the cut and polished surface serving as the light incidence surface in the light guide plates of the invention; and FIGS. 12B to 23B (only B) are diagrams (graphs) showing Fourier spectra thereof. More specifically, FIGS. 12A to 23A (only A) are diagrams each showing the surface roughness of the cut and polished surface 66 formed as the light incidence surface 30d of the light guide plate 30 used in the measurement, as measured in the direction parallel to the longitudinal direction of the light incidence surface; and FIGS. 12B to 23B (only B) are diagrams showing the surface roughness of FIGS. 12A to 23A (only A) after conversion to Fourier spectra.

The illustrated light guide plate 30 has the two light incidence surfaces 30c and 30d but their configuration is the same. Accordingly, the light incidence surface 30c is taken as a typical example in the following description for simplicity of the description.

In Example 1, a light guide plate in which a cut and polished surface with an average angle of inclination of 5° as expressed by the surface roughness shown in FIG. 12A and the Fourier spectrum shown in FIG. 12B was formed as the light incidence surface was used to measure the average illuminance at positions away from the light incidence surfaces by distances of 5 to 7 mm in the longitudinal direction of the light incidence surfaces.

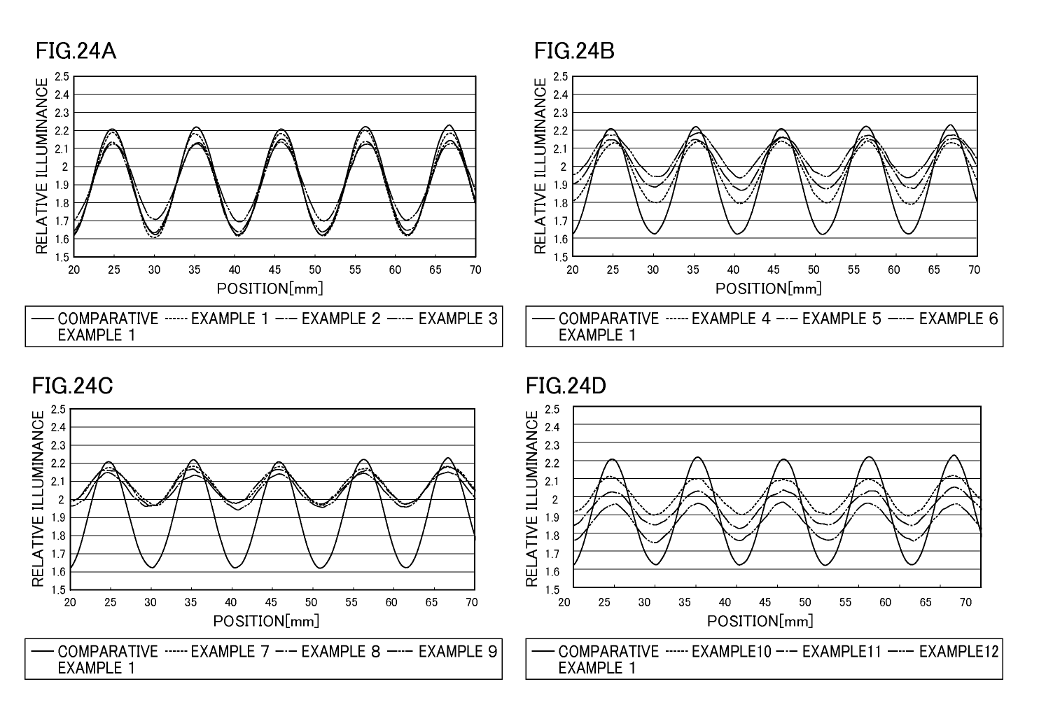

The measurement results are shown in FIG. 24A.

In Example 2, a light guide plate in which a cut and polished surface with an average angle of inclination of 10° as expressed by the surface roughness shown in FIG. 13A and the Fourier spectrum shown in FIG. 13B was formed as the light incidence surface was used to measure the illuminance in the vicinities of the light entrance portions in the same manner.

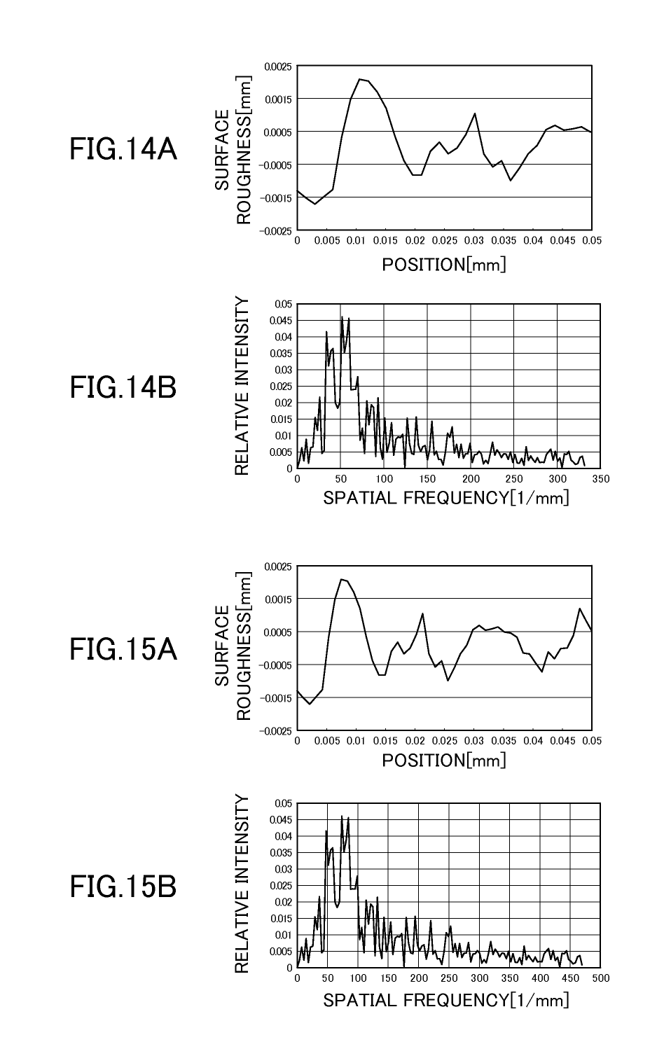

In Example 3, a light guide plate in which a cut and polished surface with an average angle of inclination of 15° as expressed by the surface roughness shown in FIG. 14A and the Fourier spectrum shown in FIG. 14B was formed as the light incidence surface was used to measure the illuminance in the vicinities of the light entrance portions.

The illuminance measurement results of Examples 2 and 3 are shown in FIG. 24A.

In Example 4, a light guide plate in which a cut and polished surface with an average angle of inclination of 20° as expressed by the surface roughness shown in FIG. 15A and the Fourier spectrum shown in FIG. 15B was formed as the light incidence surface was used to measure the illuminance in the vicinities of the light entrance portions.

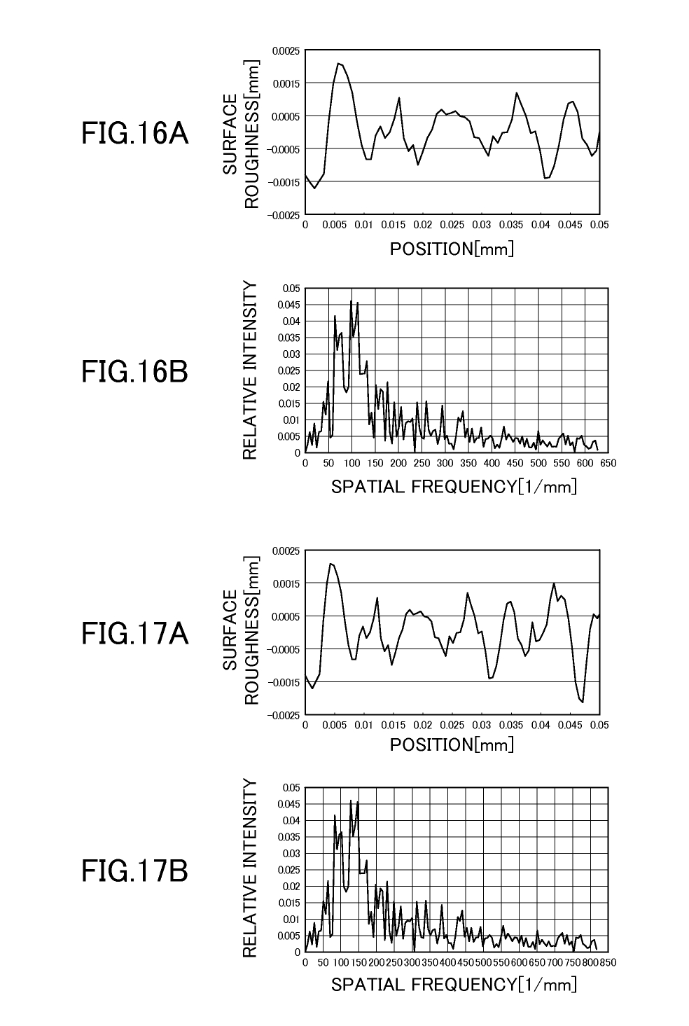

In Example 5, a light guide plate in which a cut and polished surface with an average angle of inclination of 25° as expressed by the surface roughness shown in FIG. 16A and the Fourier spectrum shown in FIG. 16B was formed as the light incidence surface was used to measure the illuminance in the vicinities of the light entrance portions.

In Example 6, a light guide plate in which a cut and polished surface with an average angle of inclination of 30° as expressed by the surface roughness shown in FIG. 17A and the Fourier spectrum shown in FIG. 17B was formed as the light incidence surface was used to measure the illuminance.

The illuminance measurement results of Examples 4 to 6 are shown in FIG. 24B.

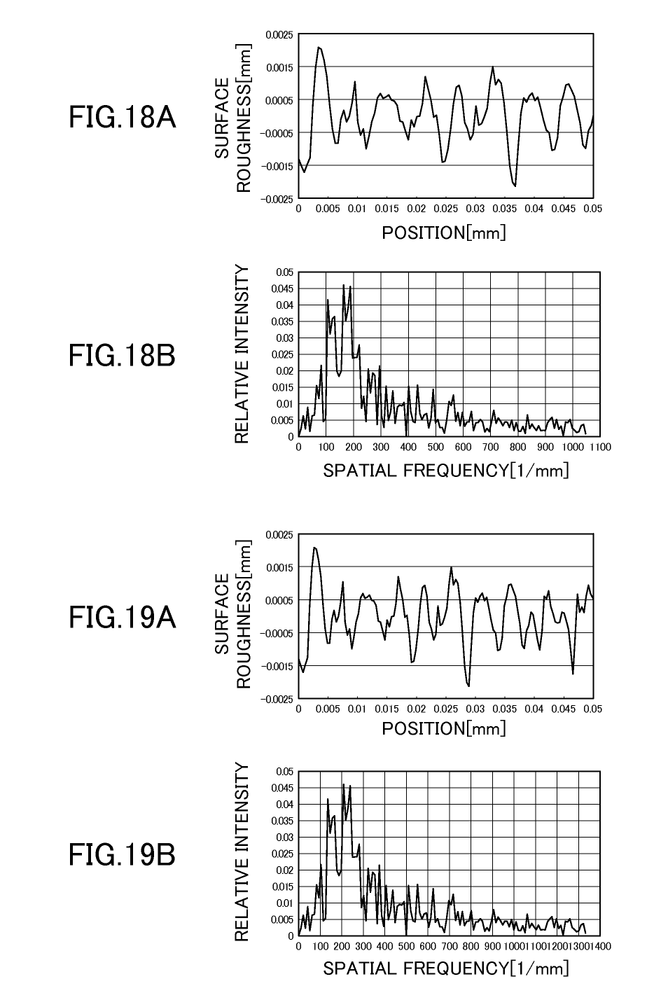

In Example 7, a light guide plate in which a cut and polished surface with an average angle of inclination of 35° as expressed by the surface roughness shown in FIG. 18A and the Fourier spectrum shown in FIG. 18B was formed as the light incidence surface was used to measure the illuminance in the vicinities of the light entrance portions.

In Example 8, a light guide plate in which a cut and polished surface with an average angle of inclination of 40° as expressed by the surface roughness shown in FIG. 19A and the Fourier spectrum shown in FIG. 19B was formed as the light incidence surface was used to measure the illuminance in the vicinities of the light entrance portions.

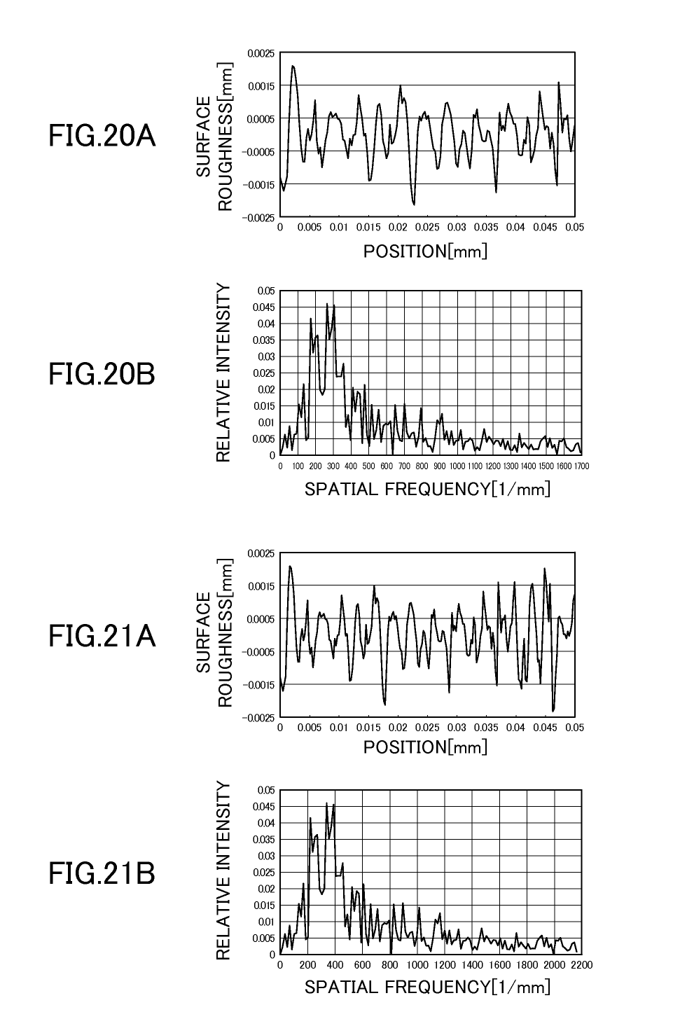

In Example 9, a light guide plate in which a cut and polished surface with an average angle of inclination of 45° as expressed by the surface roughness shown in FIG. 20A and the Fourier spectrum shown in FIG. 20B was formed as the light incidence surface was used to measure the illuminance.

The illuminance measurement results of Examples 7 to 9 are shown in FIG. 24C.

In Example 10, a light guide plate in which a cut and polished surface with an average angle of inclination of 50° as expressed by the surface roughness shown in FIG. 21A and the Fourier spectrum shown in FIG. 21B was formed as the light incidence surface was used to measure the illuminance in the vicinities of the light entrance portions.

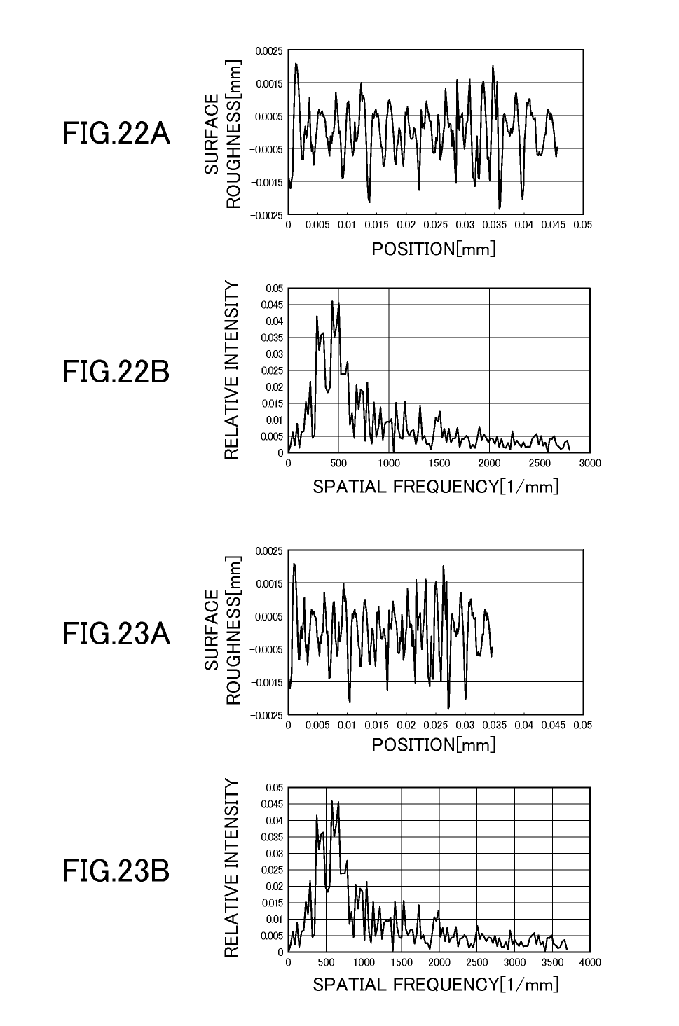

In Example 11, a light guide plate in which a cut and polished surface with an average angle of inclination of 55° as expressed by the surface roughness shown in FIG. 22A and the Fourier spectrum shown in FIG. 22B was formed as the light incidence surface was used to measure the illuminance in the vicinities of the light entrance portions.

In Example 12, a light guide plate in which a cut and polished surface with an average angle of inclination of 60° as expressed by the surface roughness shown in FIG. 23A and the Fourier spectrum shown in FIG. 23B was formed as the light incidence surface was used to measure the illuminance.

The illuminance measurement results of Examples 10 to 12 are shown in FIG. 24D.

FIGS. 24A to 24D are graphs showing the measurement results of the illuminance in the vicinities of the light entrance portions in Examples 1 to 12. The measurement results of the illuminance in the case where the light incidence surface is a specular surface are also shown as Comparative Example 1.

In FIG. 24A, Example 1 is indicated by a broken line, Example 2 by a chain line, Example 3 by a chain double-dashed line, and Comparative Example 1 by a solid line. In FIG. 24B, Example 4 is indicated by a broken line, Example 5 by a chain line, Example 6 by a chain double-dashed line, and Comparative Example 1 by a solid line. In FIG. 24C, Example 7 is indicated by a broken line, Example 8 by a chain line, Example 9 by a chain double-dashed line, and Comparative Example 1 by a solid line. In FIG. 24D, Example 10 is indicated by a broken line, Example 11 by a chain line, Example 12 by a chain double-dashed line, and Comparative Example 1 by a solid line.

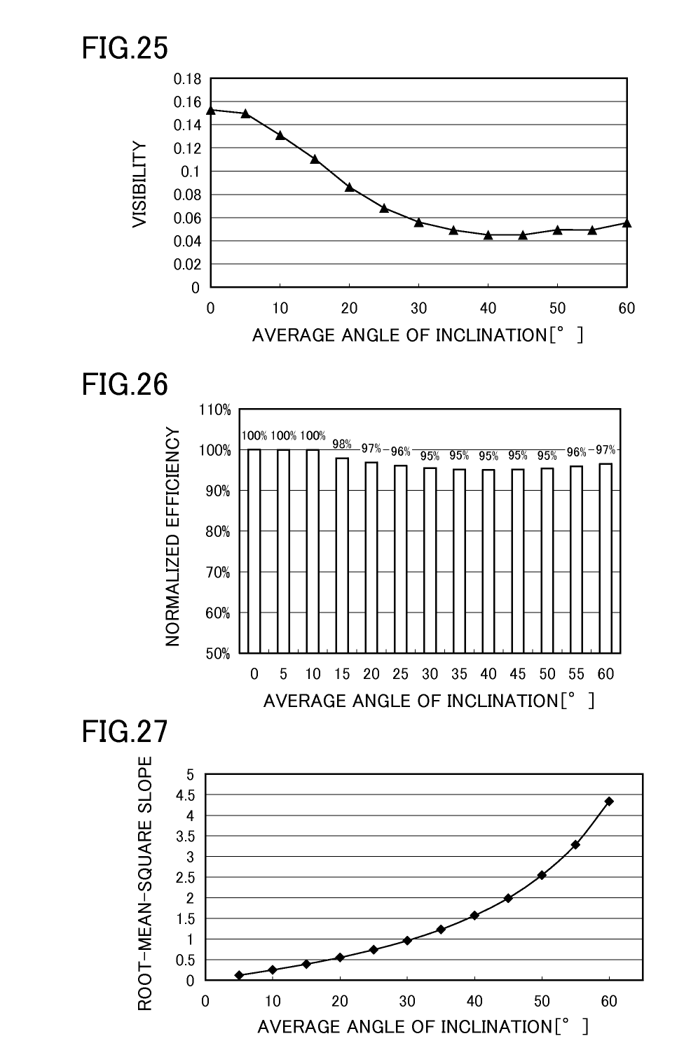

In order to evaluate the illuminance unevenness, the formula expressed by (Lₘₐₓ−Lₘᵢₙ)/(Lₘₐₓ+Lₘᵢₙ) was calculated using the maximum values Lₘₐₓ and the minimum values Lₘᵢₙ of the measured illuminance (the calculated value is hereinafter referred to as “visibility”). The relation between the calculated visibility and the average angle of inclination is shown in FIG. 25. The lower the visibility is, the smaller the relative difference between the maximum value Lₘₐₓ and the minimum value Lₘᵢₙ of the illuminance is, the smaller the illuminance unevenness is.

In addition, the relative light use efficiency was determined from the measured illuminance based on the light use efficiency of Comparative Example 1 (average angle of inclination: 0°). The determined light use efficiency is shown in FIG. 26.

By forming the cut and polished surface as the light incidence surface in each of the two-layer light guide plates in which the thicknesses of the first layer and the second layer were changed in the direction perpendicular to the light incidence surfaces, the illuminance unevenness in the vicinities of the light incidence surfaces can be reduced as compared to the light guide plate having the specular light incidence surfaces, as shown in FIG. 25. The illuminance unevenness in the vicinities of the light incidence surfaces can be reduced more advantageously by particularly setting the average angle of inclination in the cut and polished surface to 10° or more but 60° or less.

The relation between the average angle of inclination and the root-mean-square slope is shown in FIG. 27. The graph shown in FIG. 27 indicates that the root-mean-square slope is 0.25 to 4.5 when the average angle of inclination is in a range of 10 to 60°. Therefore, it is preferable to adjust the root-mean-square slope in the range of 0.25 to 4.5 because the illuminance unevenness in the vicinities of the light incidence surfaces can be reduced with advantage.

In such a range, profiles of the Fourier spectra of the surface roughness (FIGS. 12B to FIG. 23B (only B)) are the same and the spatial frequencies of the surface profiles are different.

In such a range, even in cases where a cut and polished surface is formed as the light incidence surface, the efficiency decreases by about a few percent as compared to the case of the specular light incidence surface and the efficiency is substantially the same, as shown in FIG. 26.

While the light guide plate, the planar lighting device and the method of manufacturing the light guide plate according to the invention have been described above in detail, the invention is not limited in any manner to the above embodiments and various improvements and modifications may be made without departing from the spirit of the invention.

What is claimed is:

1. A light guide plate comprising:
a rectangular light exit surface;
one or more light incidence surfaces which are provided on one or more end sides of said light exit surface and through which light traveling in a direction substantially parallel to said light exit surface enters;
a rear surface on an opposite side to said light exit surface; and
scattering particles dispersed in said light guide plate;
wherein said light guide plate includes two or more layers superposed on each other in a direction substantially perpendicular to said light exit surface and containing said scattering particles at different particle concentrations,
wherein thicknesses of said two or more layers in the direction substantially perpendicular to said light exit surface change so that a combined particle concentration has, in a direction perpendicular to each of said one or more light incidence surfaces, a first local maximum value located on a side closer to each of said one or more light incidence surfaces and a second local maximum value located at a position farther from said one or more light incidence surfaces than one or more positions of said first local maximum value and being larger than said first local maximum value, and
wherein each of said one or more light incidence surfaces is a roughened surface obtained by forming a cut and polished surface having a given periodic structure in a direction parallel to a longitudinal direction of each of said one or more light incidence surfaces.

2. The light guide plate according to claim 1, wherein said two or more layers comprise two layers including a first layer disposed on a side closer to said light exit surface and a second layer disposed on a side closer to said rear surface and containing the scattering particles at a higher particle concentration than the first layer, and a thickness of said second layer continuously changes in the direction perpendicular to each of said one or more light incidence surfaces so as to increase with increasing distance from each of said one or more light incidence surfaces, then decrease and subsequently increase again.

3. A light guide plate comprising:
a rectangular light exit surface;
one or more light incidence surfaces which are provided on one or more end sides of said light exit surface and through which light traveling in a direction substantially parallel to said light exit surface enters;
a rear surface on an opposite side to said light exit surface; and
scattering particles dispersed in said light guide plate;
wherein said light guide plate includes two or more layers superposed on each other in a direction substantially perpendicular to said light exit surface and containing said scattering particles at different particle concentrations,
wherein thicknesses of said two or more layers in the direction substantially perpendicular to said light exit surface change so that a combined particle concentration has, in a direction perpendicular to each of said one or more light incidence surfaces, a local minimum value located on a side closer to each of said one or more light incidence surfaces and a second local maximum value located at a position farther from said one or more light incidence surfaces than one or more positions of said local minimum value, and
wherein each of said one or more light incidence surfaces is a roughened surface obtained by forming a cut and polished surface having a given periodic structure in a direction parallel to a longitudinal direction of each of said one or more light incidence surfaces.

4. The light guide plate according to claim 3, wherein said two or more layers comprise two layers including a first layer disposed on a side closer to said light exit surface and a second layer disposed on a side closer to said rear surface and containing the scattering particles at a higher particle concentration than the first layer, and a thickness of said second layer continuously changes in the direction perpendicular to each of said one or more light incidence surfaces so as to decrease with increasing distance from each of said one or more light incidence surfaces and subsequently increase.

5. The light guide plate according to claim 1, wherein said one or more light incidence surfaces comprise two light incidence surfaces provided on two opposite end sides of said light exit surface and said combined particle concentration has said first local maximum value on both sides closer to the two light incidence surfaces.

6. The light guide plate according to claim 5, wherein said second layer has a maximum thickness at a central portion of said light exit surface.

7. The light guide plate according to claim 1, wherein said one or more light incidence surfaces comprise a light incidence surface provided on one end side of said light exit surface and said combined particle concentration has said first local maximum value at one position.

8. The light guide plate according to claim 1, wherein each of said one or more light incidence surfaces is the roughened surface obtained by forming a linear and uneven structure extending in a lateral direction perpendicular to the longitudinal direction of each of said one or more light incidence surfaces.

9. The light guide plate according to claim 1, wherein the cut and polished surface formed so as to serve as each of said one or more light incidence surfaces has a root-mean-square slope of 0.25 or more but 4.5 or less.

10. The light guide plate according to claim 1, wherein the scattering particles are polydisperse particles including a mixture of particles with different particle sizes.

11. The light guide plate according to claim 1, wherein said rear surface is a flat surface parallel to said light exit surface.

12. A method of manufacturing the light guide plate according to claim 1, comprising the steps of:
forming an unprocessed light guide plate comprising the two or more layers containing the scattering particles at the different particle concentrations, the light exit surface, and one or more unroughened light incidence surfaces; and
subjecting the one or more unroughened light incidence surfaces to machining to form one or more cut and polished surfaces.

13. The method of manufacturing the light guide plate according to claim 12, wherein the machining is performed by hairline finish.

14. The method of manufacturing the light guide plate according to claim 13, wherein a movement speed and a rotation speed of a blade in a milling machine, an NC router or a planer is adjusted to control a period of contact between the one or more unroughened light incidence surfaces of the unprocessed light guide plate and the blade, thereby subjecting the one or more unroughened light incidence surfaces to the machining for forming the one or more cut and polished surfaces using the blade.

15. A planar lighting device comprising:
the light guide plate according to claim 1; and
one or more light source units each disposed along a longitudinal direction of its corresponding light incidence surface in said one or more light incidence surfaces so as to face said corresponding light incidence surface of said light guide plate.

16. The planar lighting device according to claim 15, wherein each of said one or more light source units comprises a plurality of point light sources disposed at equal intervals in the longitudinal direction of each of the one or more light incidence surfaces so as to face each of the one or more light incidence surfaces, and a support member for supporting said plurality of point light sources.

17. The planar lighting device according to claim 16, wherein a length of each of said plurality of point light sources in a direction in which said plurality of point light sources are arranged is from 2 mm to 4 mm, and one or more cut and polished surfaces formed so as to serve as said one or more light incidence surfaces have a periodic structure with a pitch of 5 μm to 0.4 mm.
